(19) United States
(12) Patent Application Publication
(10) Pub. No.: US 2005/0154701 A1
(43) Pub. Date: Jul. 14, 2005

(54) Dynamic information extraction with self-organizing evidence construction

(76) Inventors: H. Van Dyke Parunak, Ann Arbor, MI (US); Peter Weinstein, Saline, MI (US); Sven Brueckner, Dexter, MI (US); John Sauter, Ann Arbor, MI (US)

Correspondence Address: John G. Posa;Gifford, Krass, Groh, Sprinkle,, Anderson & Citkowski, P.C., 280 N. Old Woodward Ave., Suite 400,, Birmingham, MI, 48009-5394, US

(21) Appl. No.: 11/001,555

(22) Filed: Dec. 1, 2004

Related U.S. Application Data
(60) Provisional application No. 60/526,055, filed on Dec. 1, 2003.

(51) Int. Cl. G06F 7/00

(52) U.S. Cl. 707/1

(57) ABSTRACT

A data analysis system with dynamic information extraction and self-organizing evidence construction finds numerous applications in information gathering and analysis, including the extraction of targeted information from voluminous textual resources. One disclosed method involves matching text with a concept map to identify evidence relations, and organizing the evidence relations into one or more evidence structures that represent the ways in which the concept map is instantiated in the evidence relations. The text may be contained in one or more documents in electronic form, and the documents may be indexed on a paragraph level of granularity. The evidence relations may self-organize into the evidence structures, with feedback provided to the user to guide the identification of evidence relations and their self-organization into evidence structures. A method of extracting information from one or more documents in electronic form includes the steps of clustering the document into clustered text; identifying patterns in the clustered text; and matching the patterns with the concept map to identify evidence relations such that the evidence relations self-organize into evidence structures that represent the ways in which the concept map is instantiated in the evidence relations.

### REFERENCE TO RELATED APPLICATION

This application claims priority from U.S. Provisional Patent Application Ser. No. 60/526,055, filed Dec. 1, 2003, the entire content of which is incorporated herein by reference.

### FIELD OF THE INVENTION

This invention relates generally to information gathering and, in particular, to dynamic information extraction with self-organizing evidence construction.

### BACKGROUND OF THE INVENTION

Driven by the need for more efficiency and agility in business and public transactions, digital data has become increasingly accessible through real-time, global computer networks. These heterogeneous data streams reflect many aspects of the behavior of groups of individuals in a population, including traffic flow, shopping and leisure activities, healthcare, and so forth.

In the context of such behavior, it has become increasingly difficult to automatically detect suspicious activity, since the patterns that expose such activity may exist on many disparate levels. Ideally, combinations of geographical movement of objects, financial flows, communications links, etc. may need to be analyzed simultaneously. Currently this is a very human-intensive operation for an all-source analyst.

Active surveillance of population-level activities includes the detection and classification of spatio-temporal patterns across a large number of real-time data streams. Approaches that analyze data in a central computing facility tend to be overwhelmed with the amount of data that needs to be transferred and processed in a timely fashion. Also, centralized processing raises proprietary and privacy concerns that may make many data sources inaccessible.

Our co-pending U.S. patent application Ser. No. 2003/0142851 resides in a swarming agent architecture for the distributed detection and classification of spatio-temporal patterns in a heterogeneous real-time data stream. The system is not limited to geographic structures or patterns in Euclidean space, and is more generically applicable to non-Euclidean patterns such as topological relations in abstract graph structures. According to this prior invention, large populations of simple mobile agents are deployed in a physically distributed network of processing nodes. At each such node, a service agent enables the agents to share information indirectly through a shared, application-independent runtime environment. The indirect information sharing permits the agents to coordinate their activities across entire populations.

The architecture may be adapted to the detection of various spatio-temporal patterns and new classification schemes may be introduced at any time through new agent populations. The system is scalable in space and complexity due to the consequent localization of processing and interactions. The system and method inherently protect potentially proprietary or private data through simple provable local processes that execute at or near the actual source of the data.

The fine-grained agents, which swarm in a large-scale physically distributed network of processing nodes, perform three major tasks: 1) they may use local sensors to acquire data and guide its transmission; 2) they may fuse, interpolate, and interpret data from heterogeneous sources, and 3) they may make or influence command and control decisions. The decentralized approach may be applied to a wide variety of applications, including surveillance, financial transactions, network diagnosis, and power-grid monitoring.

### SUMMARY OF THE INVENTION

This invention extends the prior art by providing a data analysis system with dynamic information extraction with self-organizing evidence construction. The approach finds numerous applications in information gathering and analysis, including the extraction of targeted information from voluminous textual resources.

One disclosed method involves matching text with a concept map to identify evidence relations, and organizing the evidence relations into one or more evidence structures that represent the ways in which the concept map is instantiated in the evidence relations.

The text may be contained in one or more documents in electronic form, and the documents may be indexed on a paragraph level of granularity. The evidence relations may self-organize into the evidence structures, with feedback provided to the user to guide the identification of evidence relations and their self-organization into evidence structures.

The method may further include the steps of identifying patterns in the text, and matching the text with the concept map using the patterns. Linguistically-oriented regular expressions may be used to recognize relations in the text. For example, the text is preprocessed to identify basic grammatical constituents such as noun phrases and verb phrases. Emphasis may be placed on pronoun references and similar linguistic phenomena that have a significant presence in the test.

The evidence relations may include a reference to a document, a paragraph, or metadata. Additionally, the evidence relations may include a reference to the pattern used to match the concept map relation, and the terms in the document text that were matched to the pattern. The evidence relations may also include a reference to the exact terms in the text that match to the concept map concepts and relations. Such terms may be as specific, or more specific, than the corresponding concepts and relations in the concept map.

The evidence relations may also include an estimate as to the confidence in the evidence relation, based on the match of the relation to the textual data. The confidence estimate may be based in part on a measure of the absence of supporting evidence, or may reflect the degree to which the evidence relation fits with other evidence into the larger pattern defined by the concept map.

The method may further include the step of clustering the text prior to matching the text with the concept map. As such, the evidence structures may represent the ways in which the concept map is instantiated in the document evidence by providing mutually compatible evidence relations connected to each other according to the template provided by the concept map.

According to a preferred embodiment, a method of extracting information from one or more documents in electronic form, comprising the steps of clustering the document into clustered text; identifying patterns in the clustered text; and matching the patterns with the concept map to identify evidence relations such that the evidence relations self-organize into evidence structures that represent the ways in which the concept map is instantiated in the evidence relations.

Feedback from the user guides the identification of patterns, the matching of textual patterns with the concept map, and their self-organization into evidence structures. The documents are preferably indexed on the paragraph level of granularity, with patterns using linguistically-oriented regular expressions to recognize relations in the text. Each document is preprocessed to identify basic grammatical constituents such as noun phrases and verb phrases, including the step of resolving pronoun references and similar linguistic phenomena that have a significant presence in the test. The evidence relations may include a reference to a document, a paragraph, or metadata.

### BRIEF DESCRIPTION OF THE DRAWINGS

FIG. 1 provides a notional Architecture of Ant CAFÉ;

FIG. 2 illustrates how an Ant CAFÉ team uses an existing environment to test and develop analyst profiling techniques;

FIG. 3 provides a Linguistic Model for Scenarios, Hypotheses, and Strategies;

FIG. 4 shows Metastrategies as State Machines;

FIG. 5 illustrates Ant-Based Pattern Detection;

FIG. 6 depicts two Models of Computation;

FIG. 7 shows the evolution of the Current Profile with simulated feedback;

FIG. 8 illustrates an ant sorting simulation at 5K, 50K, and 500K steps showing the early development of clusters and the improvement if more time is available;

FIG. 9 depicts Structure ants Constructing a Topology;

FIG. 10 provides a Composite Adaptive Matching Evaluation;

FIG. 11 relates to Pheromone Visualization;

FIG. 12 shows a Pheromone Reward Bucket Brigade;

FIG. 13 depicts the Integration of Ant CAFÉ Modules;

FIG. 14 shows a abstract and unrealistically small concept map;

FIG. 15 is a schematic of a fragment of the clustered paragraph matrix;

FIG. 16 depicts Evidence relations;

FIG. 17 illustrates success in matching a relation, which encourages visits to the same paragraph for neighboring relations;

FIG. 18 shows two kinds of “join” decisions;

FIG. 19 is top-level screen for reviewing evidence;

FIG. 20 is directed to evidence found to support a relation;

FIG. 21 provides Ant CAFÉ components;

FIG. 22 shows how current match positions migrate in response to pheromones;

FIG. 23 shows how match positions of relations in the same structure are forced to the Most Specific Subsuming synsets;

FIG. 24 is a mockup of the evidence assembly demo display;

FIG. 25 depicts Ant CAFÉ Information Flow; and

FIG. 26 related to assessing Lack of Evidence via Adaptive Ant Populations.

### DETAILED DESCRIPTION OF THE INVENTION

Ant CAFÉ (Composite Adaptive Fitness Evaluation) implements novel techniques of user modeling and swarm intelligence to achieve dramatic improvements in four of the five NIMD (Novel Intelligence from Massive Data) Technical Areas (TAs) (Table 1). The approach exploits emergent, system-level behavior resulting from interaction and feedback among large numbers of individually simple processes to produce robust and adaptable pattern detection.

Digital ants swarming over massive data can efficiently organize (TA 4) and (with fitness evaluation from human analysts) analyze it with multiple concurrent strategies to detect multiple hypotheses and scenarios (TA 3). Imitating colonies of insects such as ants, termites, and wasps [18], Ant CAFÉ replaces central pattern recognition with a host of digital ants that swarm over the data, detecting and marking composite patterns. This highly parallel process yields quick approximate results that improve with time, scales to handle massive data, and composes templates in novel ways to counter analyst denial and deception. Analyst effort shifts away from document sorting and toward strategy setting and result evaluation.

An analyst model (TA 1) can be derived based on prior and tacit information and on analyst actions. The model includes an Analyst Profile that automatically captures a composite view of an analyst's interests and preferences, and an Analyst Activity Stack that reflects the analyst's hypothesis formation process. After initialization, the model adapts automatically based on the analyst's actions. The behaviors for digital ants are generated from the analyst model, and adapt in response to fitness evaluation by the analyst.

We claim that in spite of the distributed, emergent nature of ant computation, humans can manage it effectively (TA 5), using reports of hypotheses and scenarios selected using digital pheromones and evaluating their fitness. A novel “ant bucket brigade” enables the entire digital ecosystem responsible for generating a useful pattern to adapt in response to this fitness evaluation. This interactive approach is provably more powerful computationally than the traditional “input-process-output” model, and enables the system to exploit the respective strengths of humans for deep analysis and of machines for massive repetition of simple computations.

TABLE 1
Ant CAFÉ Innovations and Benefits

| Tech Area | Ant CAFÉ Innovation | Benefit |
|---|---|---|
| 1. Modeling | Models are derived from | Analysts think in domain terms |
| analysts & | analyst actions generate | Model adapts automatically |
| process | ant species | Learned profiles and strategies guide |
| | | future work. |
| | | Identifies distractions, biases, denial and |
| | | deception. |
| 3. Multiple | Scenarios, Hypotheses, | Simple templates on individual ants |
| Scenarios, | Strategies have unified | combine in different ways to recognize |
| Hypotheses, | linguistic model | composite patterns. |
| Strategies | Digital pheromones mark | Patterns include high-level (e.g., |
| | distinctions; permit layered | hypotheses, analyst ID's) as well as |
| | processing | base document features. |
| | | Composite nature avoids analyst bias |
| 4. Massive | Unit of computation is | Scales to handle large collections of |
| Data | swarming digital ant | documents |
| | | Computation is “any time,” producing |
| | | rough results early and more detail as |
| | | time passes |
| 5. Human | Analysts evaluate fitness of | System dynamically adapts to analyst |
| Info | intermediate results to | needs |
| Interaction | guide search | Shifts analyst effort from filtering |
| | Bucket brigade distributes credit | massive data to evaluating results and |
| | | guiding strategy. |

Technical Rationale, Technical Approach, and Constructive Plan

Ant CAFÉ's major innovations rest on a solid rationale of previous research with well-understood benefits. Our technical approach supports a realistic constructive plan for achieving the benefits.

Modeling Analysts and Process

We model an analyst as a profile (reflecting the analyst's interests) plus an activity stack (reflecting the hypothesis formation process). Our model dynamically learns by modifying the analyst profile based on recent interactions with the GBA (Glass Box Analysis)¹ or similar environment, augmented by the information in the analyst stack [1]. Ant CAFÉ uses the analyst model to create search templates that guide the digital ants.
¹Acronyms are defined on first use, and also in a table at the end of this volume.

The analyst profile captures the analyst's areas of interest, as well as the weight that she assigns to various types of information sources. More formally, the profile is a vector of class-value-weight triplets: classes are data types, values are instances of such types, and weights describe the analyst's level of interest. Examples: (terrorist, “Bin Laden”, 1.0) and (geographic_area_of_interest, “Middle East”, 0.9). The activity stack stores recent analyst activity, specifically data items the analyst recently accessed, the analyst's strategy, the scenarios being considered, and preliminary hypotheses being formed.

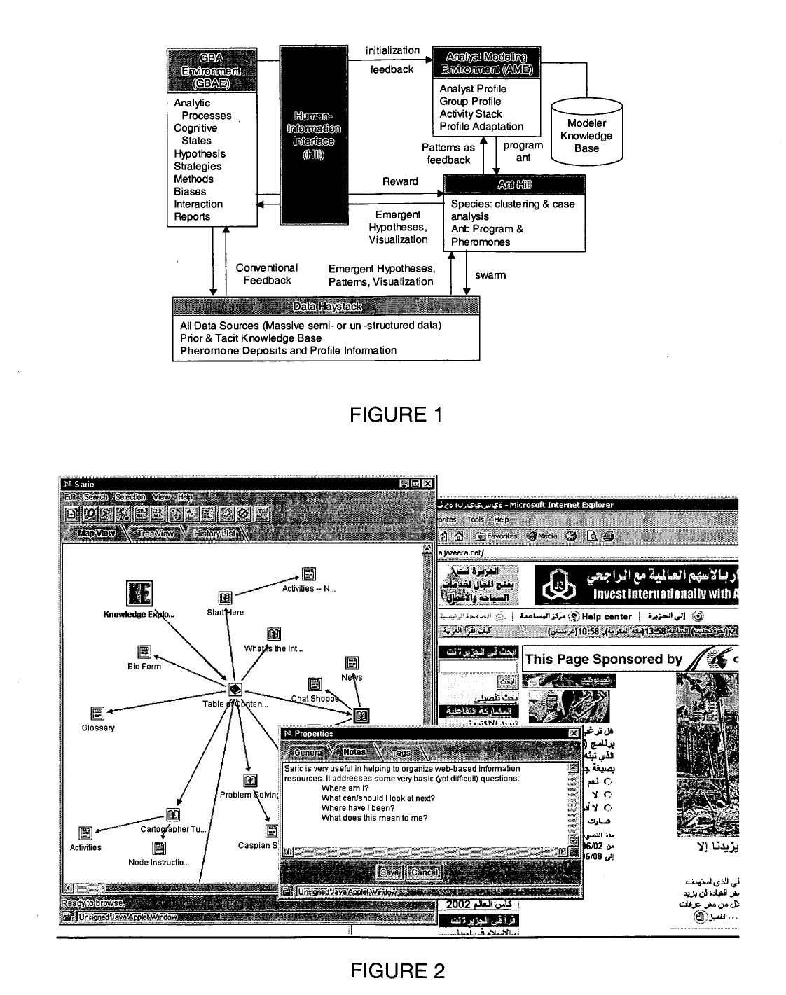

FIG. 1 shows Ant CAFÉ's overall architecture. The Analyst Modeling Environment (AME) engages the analyst in an initial dialog to learn the analyst's interests. The system will ask about such key topics as geographic areas of interests, types of activities being analyzed, individuals to watch, and organizations to track. Topics consist of class-value pairs. The analyst will be very aware of his interest in some topics such as geographic regions of interest, and will not fully realize the importance of others. We refer to the former topics as explicit and to the latter as implicit. The profiling system will ask the analyst for a list of explicit topics, and elicit information (e.g., pairwise comparisons) that permit the induction of weights denoting level of interest. It will ask for input on implicit topics by presenting the analyst with a task-specific (possibly analyst-specific) list of implicit topics and asking for feedback (e.g., interest or no interest, partial orderings). The list of implicit topics will be continuously refined over time based on the analyst actions as well as those of similarly tasked colleagues. The AME will also request initial strategy information from the analyst (e.g., the type of search techniques the analyst plans to use).

Some parameters in the Analyst Profile control reinforcement of the digital ants. Thus, as an analyst's profile is dynamically created, AME communicates the changed information to the Ant Hill to modify the information processing behavior of the digital ants. Additionally, analysts can modify these parameters directly to guide the evolution of the ants more precisely.

As the analyst begins to work, and the GBA environment (GBAE) tracks her actions², the modeling system adapts the weights of the implicit topics in the profile, using two adaptive algorithms. Besides obtaining feedback from the GBAE, the AME can also take advantage of the feedback from the digital ants (FIG. 2) in the form of newly detected patterns and hypotheses. The profile adaptation algorithms use the feedback to update the current profile. The AME also uses the feedback to update the analyst activity stack.
²This document assumes the existence of the GBA. The modeling system will work with any other NIMD platform or, more generally, with any source of analyst activity (e.g., a log of analyst activities).

The modeling system constantly refines the analyst's profile using feedback from both the GBAE and the Ant Hill (FIG. 1). By comparing the initial profile with the current profiles with fixed static weights and with modified static weights, we can:
Show the analyst his current interest profile;
Point out how his focus has changed as more information is processed;
Note implicit biases (topics that were selected yet never explored);
Warn of premature hypothesis formation if insufficient instances of a data type are explored before hypothesis is formulated; and
Guide the automatic search by the emergent behavior agent system described below.

In addition to generating and adapting profiles of individual analysts, the AME maintains group profiles of a team of analysts. Group profiles facilitate collaboration and knowledge sharing among analysts, and are represented and initialized similarly to individual profiles. The adaptation of a group profile considers feedback from all group members.

To obtain preliminary results before the GBAE is completed, we will use Netrospect [27] (FIG. 2) to gather information on analyst activities. Netrospect, already implemented at Sarnoff under government support, works in tandem with most web browsers. It automatically tracks all surfing, creates a map of visited sites, and allows users to annotate sites and add relationship links between physically unrelated sites. By tasking one of our team members (previously employed by the intelligence community) to perform intelligence analysis tasks on Web data and tracking her actions, we can gather GBAE-like data to drive our work. We will also explore the design of adaptive profile policies by using Profile Workbench.

The central benefits of our analyst model are that it captures the essence of the analyst's interests, and that it does so in an explicit manner. Model information creates templates that drive the system's search behavior. Model data is also fed back to the GBA so that analysts may examine the accuracy of the profile being generated.

Multiple Scenarios, Hypotheses, and Strategies

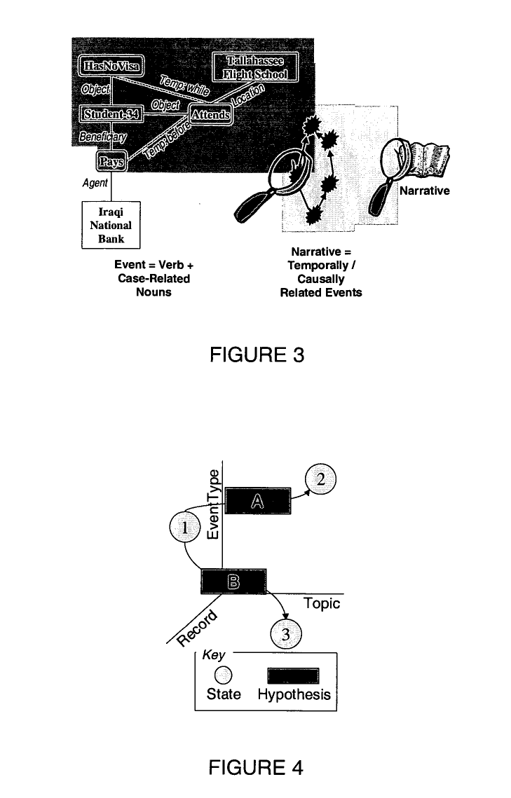

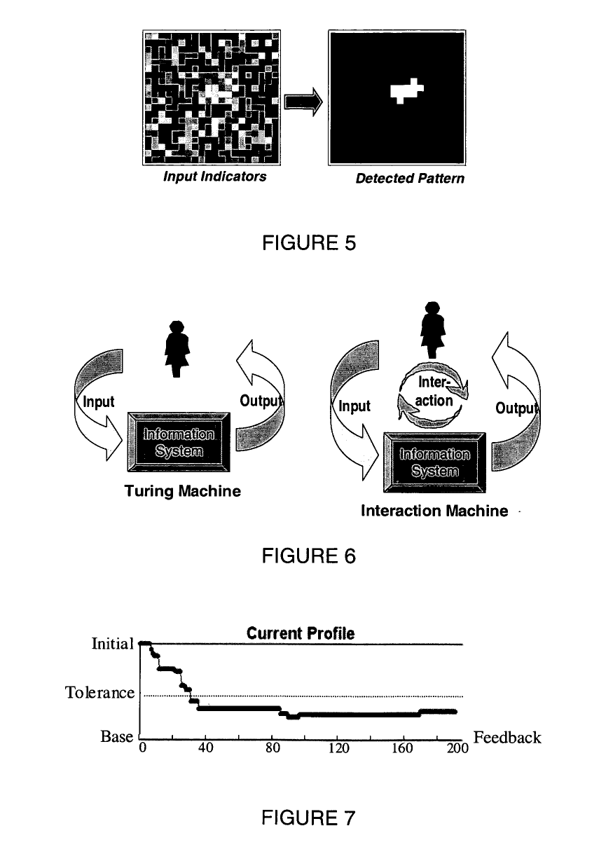

Our approach to scenarios and hypotheses is based on the insight that both are distinct instantiations over a formal model of narrative. Analyst strategies build on the same concepts in a slightly different way. FIG. 3 shows our underlying linguistic model: an event is a case frame (a verbal concept with a set of nominal concepts related to it by case grammar [6, 17]),³ and a narrative is a set of events linked by temporal and causal relations⁴, and The nominal concepts in a case frame may be variables, or they may be bound to specific entities.
³Our case analysis uses Cook's five-case matrix model [5-7] of Agent, Experiencer, Beneficiary, Object, Location, augmented with Temporal to capture time relationships among propositions. This system integrates a wide variety of case grammatical insights in a relatively simple structure. Cook's cases (and Temporal) are hypercases that subsume more specific cases, and we expect that we will need to work at the level of subcases in many analyses.

⁴Our discourse analysis builds on Longacre's paragraph grammar [13], which defines a set of paragraph types with slots filled by lower-level paragraphs (ultimately, elemental case frames). This slot-filler structure is structurally very similar to a case frame, enabling us to use the same basic pattern-matching mechanisms for both of them.

Scenarios and hypotheses differ in how the variables are instantiated. A hypothesis relates known facts and patterns. It focuses on instantiated variables, and the narrative provides a pattern of relationship among these facts. The primary analytical activities with a hypothesis are to form it and then assess its credibility at a point in time. An example of a hypothesis is that the manager of the Dearborn Meat Market in Warren, Michigan is laundering funds in support of a Columbian drug cartel.

A scenario refines the notion of hypothesis to introduce the notion of temporal evolution. This evolution may take the form of new or changed instantiations of variables, or of changed temporal or causal relations among events. The primary analytical activities with a scenario are to search the space of possible evolutions and evaluate the relative likelihood of different alternatives. Extending the previous example, a scenario might explore alternative mechanisms for funds transfer, including wire transfers, courier, and conversion to precious metals, to determine which of them is more likely to be used by the manager.

Through this unifying model a common set of tools for detecting narrative structures in massive data can support creation, testing, tracking, and refinement of both forms of analytical product.

Informally, an analyst's strategy dictates how the analyst's biases, preferences, and analytical focus change during the ongoing encounter with information. Formally, we define both a strategy and a metastrategy.

A strategy is defined in terms of the state space Records×Entities×Events, where:
Records are information sources, including both modalities (e.g., imagery vs. news feeds vs. reports from operatives) and different instances of the same modality (e.g., Jerusalem Post vs. Le Monde);
Entities are potential fillers of case slots, and include individuals, organizations, locations, and inanimate objects; and
Events are case frames.

The semantics of being at a given <Record, Entity, Event>is that the analyst's attention is centered there. E.g., let ‘*’ be a wild card. Then <˜JerusalemPost, *, *>means that the analyst is currently discounting information from the Jerusalem Post, while <*, MiddleEast, Meet( member_of( Al-Qaeda), head-of-state)>expresses an interest in any meeting in the Middle East between a member of Al Qaeda and a head of state.

A strategy is a subset of state space, defined as a tuple <template, preferences>, where:
Template is a hypothesis with unfilled slots. A template spans hyperplanes of state space that exhibit the required case frames and restrictions on entities filling those frames; and
Preferences are partial orders over records and entities.

Thus a strategy might be to seek (preferentially in newspapers) for meetings (a case frame) among known terrorists (restriction on entities), followed (discourse relation) by a bombing involving one of those terrorists (case frame with restricted entities).

A metastrategy represents how the analyst moves from one strategy to another as different hypotheses are substantiated (FIG. 4). State 1 indicates analyst focus on reports from operatives dealing with organizational memberships (“Belong“case frame) of foreign nationals in the US. In the presence of a strong hypothesis that some university students have links to Al Qaeda (hypothesis A), the strategy shifts to reports filed by universities with INS on visa status of foreign students (state 2), while a strong hypothesis linking foreign businessmen to Islamic charities (hypothesis B) shifts the strategy to IRS reports on banking activities of such businessmen (state 3).

Thus all elements of our model use slot-filler linguistic formalisms to represent events. Scenarios, hypotheses, and strategies use discourse grammar to relate events into narratives; meta-strategies use state transitions to relate them to shifts in analyst focus.

The benefits of this integrated formalism is that templates corresponding to different details of an analyst's profile can be combined in different ways to yield alternative scenarios and hypotheses (thus the “composite” in CAFÉ). This potential for recombination, with the stochastic element of swarming computation, allows Ant CAFÉ to discover novel perspectives that can circumvent analyst bias and guard against denial and deception.

Massive Data

A fundamental challenge of NIMD is that more data is available than analysts can personally examine. Some automated mechanism must screen the data to identify patterns that merit the scarce analyst attention.

We handle massive data using “swarm intelligence” [18], the self-organizing methods used by colonies of insects to exploit and refine structure in their environments. Though individually very simple, these organisms can understand and exploit an environment vastly larger than themselves by interacting with one another through changes they make to that environment, either by moving pieces of it around, or by marking it with chemical markers of different flavors (“pheromones”). For example, ants find remote food sources and construct optimal trail networks leading to them, and termites organize soil into huge and elaborately structured hills. We have successfully employed swarm intelligence for complex data analysis [19] (Figure) and command and control [20], using simple computer programs instead of ants and incrementing of labeled scalar variables in place of pheromones.

Swarm intelligence relies on a structured environment that serves as a substrate for self-organization. Massive data has intrinsic topology, including topological relationships in time, space, and other dimensions that can serve as a support for interpretation. For example, time-stamped data items are embedded in an order relation; data items associated with geographical locations are embedded in a 2-D manifold; data items associated with individuals are embedded in an organizational structure. The first two topologies are explicit in immature data, while the third is an example of a topology that is initially implicit and becomes explicit through analysis.

Instead of trying to filter massive data through a central pattern recognition system, Ant CAFÉ releases a host of digital ants to swarm over the data and organize it. This process is highly parallel and can be distributed across as many physical computers as desired, providing natural scaling to deal with massive data. We assume that the data exists in the form of “documents,” which may include textual documents, images with associated metadata (e.g., time, place, spectral range), transcripts of audio sources, and reports from operatives or other analysts. The task of the digital ants is then to organize these documents into meaningful structures for review by the analyst.

A major challenge in engineering swarm intelligence systems is tuning the behavior of the digital ants so that their interactions yield the desired global behavior. Nature does this tuning using evolutionary mechanisms, which we have successfully emulated in an engineered system of digital ants [28]. We breed ants that behave the way we want, much as a farmer might breed cows to increase milk yield. The project name “Ant CAFÉ” derives from this process of Composite Adaptive Fitness Evaluation (CAFÉ). The analyst influences the system by evaluating the fitness of digital ants, based on their detection of composite patterns, and the population adapts in response to the analyst's evaluation.

The benefits of this approach are that the population of digital ants can be scaled arbitrarily to handle large, distributed collections of documents, and that swarming mechanisms yield early approximate results that become more precise as they are given more time to run.

Human-Information Interface

An innovation in Ant CAFÉ's human interface is in the close interaction between Ant CAFÉ and the human user (FIG. 6). Conventional information technologies are oriented around the concept of a transaction, in which the user poses a query, the system computes for a while, and then returns a response. This “input-process-output” model is embodied in the theoretical model of a Turing machine [30]. This model leads to the Church-Turing hypothesis, which states that a Turing machine can compute anything that can be effectively (that is, algorithmically) computed [8].

In contradiction to the Church-Turing hypothesis, recent work has shown that another class of machines, interaction machines, are strictly more powerful than Turing machines, and can compute things that Turing machines cannot [31, 32]. The key distinction of such machines is that they consist of interacting processes. Ant CAFÉ exploits this added power in two ways. 1) The population of interacting digital ants in itself constitutes an interaction machine. 2) The human analyst interacts with the system repeatedly between submission of the initial input and delivery of the final answer. In our use of synthetic evolution to tune and configure digital ants, the human executes the “fitness function” that guides the development of individual ant behaviors. In exchange for this increased supervision by the analyst, the system delivers better discrimination of documents selected for detailed analyst attention. Thus we shift analyst effort away from sifting through irrelevant material and toward rewarding patterns detected by the Ant Hill.

To support Ant CAFÉ, a human interface must give the human user a view of intermediate states of the global system behavior, and permit the human to express an opinion about it. Ant CAFÉ does this in two ways. First, Ant CAFÉ can present intermediate results to humans in terms of instantiated case frames (hypotheses) and their constituent entities. The user will reinforce those patterns that seem most promising, and discourage those that are not useful. Second, analysts using Ant CAFÉ can display their profile, and by accepting or modifying it, indirectly reward ant behavior. In either case, through the CAFÉ mechanisms, subsequent generations of digital ants will support the development of patterns more in line with the wishes of the human analyst.

The benefit of our interactive approach to human-information interaction is that the resulting system is more powerful and dynamic than a traditional transaction system.

### Technical Approach

Modeling Analysts and Process

We model analysts and their process with an Analyst Profile augmented with an Analyst Activity Stack. We discuss the former in more detail than the latter (due to space constraints), explain how our model supports analyst collaboration, and show how the model guides the searches of the Ant Hill.

Analyst Profiles

There are several approaches to user profile representation. Linear models combine positive and negative traits (e.g., weighted or Boolean class vectors used [3, 12, 16, 21, 26, 29, 34]). Many mail filtering programs use rule-based profiles (e.g., [14]). Prototype-based profiles model the user by a similarity comparison between the example and a prototype, the latter viewed as summing evidence for or against certain decisions (e.g., [25]). We will use class vectors, a type of linear model, because they are versatile, highly interpretable and perform well [22, 26].

The profile is a vector of class-value-weight triplets (Section 2.1.1). For a given intelligence domain, we develop a set of class-value pairs (i.e., profile parameters) that capture the analyst's areas of interest, preferences and analytic characteristics. Some profile parameters are explicit and others are implicit in terms of the analyst's awareness. A weight denoting the analyst's level of interest or importance is associated with each parameter. These parameter weights capture key aspects of the analyst's approach to intelligence analysis, and distinguish analysts from each other, even when they work in the same area.

Table 2 illustrates a typical set of parameters. Despite the simplicity of this structure, in principle it is possible to paint the complete (or at least good enough) picture of the “true” profile, given enough parameters. In practice, we need only to capture those aspects that are most relevant to the analysts' tasks. We can extend this structure to make it more sophisticated. E.g., each parameter in the profile may itself be a vector of sub-parameters if the concept being captured is sufficiently complex.

TABLE 2
Sample Parameters for Analyst Profile

| Parameters | Possible Values |
|---|---|
| Area of Interest | Middle East, Europe, Pacific Rim, Africa |
| Preferences | Image analysis, press analysis, field reports |
| Cognitive Style | Analytic, experimental, practical, inspirational |
| Methodologies | Depth First Search (focus on one lead a time), |
| | Breath First Search (look for pattern among |
| | multiple leads) |
| Biases | Preference for college-educated sources, |
| | usually ignores open sources |

Profiles.

Our model assumes that concepts embodied by parameter/value pairs guide real analysts' decisions. Our goal in building an analyst profile is to estimate the weights that the analyst applies to each parameter.

Base profile (Pb) refers to the profile we would generate if we had perfect complete knowledge of the analyst's interests. Pb is not directly observable. Instead, we seek to estimate it by observing analyst actions. Pb is not assumed to be static.

At any moment, our best estimate of Pb is the current profile (Pc). Once initialized, Pc adapts in response to analyst actions in order to track changes in interest, experience, protocol, etc.

Pc is initialized to an initial profile (Pi). We determine the initial weights associated with explicit parameters through a question and answer session between the system and the analyst. The initial weights assigned to the implicit parameters are more difficult to produce (see Section 2.1.1 for a proposed approach) and the system may take longer to approximate their true values.

Profile Adaptation Using Feedback.—We adapt Pc by learning from feedback (choices made by the analyst). The feedback comes from the analyst's activity stack and the activity recorded in the GBAE. If the analyst selects one item out of a list of data items in the same category, we assume that the selected item is more important than others that are visible but not selected.

We induce a matching function, a function that measures the extent a data item “matches” a given profile. With this function we can rank a list of data items with a given profile such that the better the fit the higher the rank.

Assume that the items are ranked using the matching function with Pc. If some items rank higher than the selected item, then Pc≠Pb. Had they been the same, the system would have ranked the selected item first. The items that were ranked higher but were not selected and the actual selected item form the feedback from which the system can learn and modify Pc toward Pb.

Two factors complicate this process. 1) The profile may induce only a partial order over the items. 2) The ranking function may be probabilistic, not deterministic. That is, it may only predict the frequency with which the analyst will prefer one item over another; a single selection contrary to this probability does not mean that the profile has shifted. (This latter case is a generalization of the first: in a partial order, the preference between imcomparable items is 50%.) These considerations may require an implementation in which the system observes a series of choices and then compares them with predicted frequency.

Adaptation Algorithms.—We propose two approaches for adapting analyst profiles. One keeps the weights of explicit parameters (i.e., topics) fixed, thus keeping the analyst on track. The other allows them to change, helping detect analyst distraction or denial.

We have developed several adaptation algorithms in previous work [1]. We tested our algorithms by implementing the Profile Workbench. This software tool supports simulations for studying the behavior of profile learning algorithms. Figure shows the evolution of Pc using a particular algorithm. Both Pb and Pi are randomly and independently generated. One feedback is one choice computed with Pb. The goal is to adapt the current profile with successive feedback. Pi (top line of plot) has a large deviation from Pb (the X-axis). The tolerance (dashed line) indicates the deviation value at which the user thinks Pc is “close enough” or converged to Pb. With further feedback, the deviation of Pc becomes smaller. In this example, the deviation decreases steadily at first, indicating rapid adaptation, then levels off after about 35 feedback cycles, when the result is within tolerance.

Ant CAFÉ will extend our previous adaptation algorithms and define new ones. We will study their performance in the intelligence analysis context by extending the Profile Workbench to provide an environment to simulate, analyze, and evaluate the algorithms.

Analyst Activity Stack

Analysts use various strategies in searching for new hypotheses. A strategy consists of a template and a set of preferences. The former is part of the analyst activity stack, while the latter are captured by the profiles. A shift in strategy (represented by a metastrategy) causes changes in the template, the set of preferences, or both. During profile adaptation, a major change in the profile signals a potential shift in strategy. This may result from a conscious decision by the analyst, or unconsciously from distractions of the current environment, personal bias, or denial and deception. Thus, the profile and stack combine to warn the analyst of possible problems.

Analyst Collaboration

A common model can capture the combined interest of a team of analysts cooperating on a particular product. The AME represents and adapts group profiles similarly to individual ones, with two differences. 1) Group profile adaptation employs feedback from all group members. 2) There is no activity stack for the group per se. Instead, the set of the activity stacks of the individual members is used.

The dynamics of group profiles evolution differ from individual profiles. E.g., in a group setting feedback from different members may conflict and cause the profile to fluctuate instead of converging, either because the members are not cooperating or because they have very divergent strategies. Thus, modeling groups is useful both for understanding collaboration techniques as well as for detecting strategy differences.

AME-Ant Hill interaction

Ant CAFÉ's ants are “genetically” programmed with preference information from analyst profiles and/or templates from the activity stack. Different aspects of the composite information form the “genetic materials” that determine ant behavior. Thus, by changing either the profile or the activity stack, the analyst can manipulate the next generation of ants. For example, if the weight of a geographic interest parameter increases radically, ants will evolve to prefer searching for information related to that region of the globe.

To facilitate ant manipulation, the analyst model carries information specific to the ants (e.g., ant population size, rate of generation, and life expectancy of the ants). Also, the patterns and hypotheses the ants detect are fed back to the AME. These emergent hypotheses are pushed into the analyst activity stack and may become a template for a future search.

### Multiple Scenarios, Hypotheses, and Strategies; Massive Data

Our technical approach includes multiple interacting species of digital ants, digital pheromones as a coordination mechanism, and the ants' life cycle. Although other embodiments are possible, with respect to this disclosure “ant” and “pheromone” should be taken to mean software components executed in a purely digital environment.

Ant Species

Ant CAFÉ uses two distinct species of digital ants with separate but related processing tasks. Clustering ants group documents that are related on the basis of similar keyword vectors. (Keywords for image documents are drawn from metadata, such as time, location, and spectral range.) Structure ants focus their attention on the groups assembled by the clustering ants and apply case and discourse grammar to construct scenarios and hypotheses for analyst review.

Clustering ants implement an algorithm modeled on how natural ants sort their nests [9].

1. Wander randomly.

2. Sense nearby objects, remembering recently (10 steps) sensed objects.

3. If an ant is not carrying anything when it encounters an object, decide stochastically whether or not to pick up the object. The pick-up probability decreases if the ant has recently encountered similar objects.

4. If an ant is carrying something, at each time step decide stochastically whether or not to drop it, where the drop probability increases if the ant has recently encountered similar items in the environment.

The random walk means the ants eventually visit all objects in the nest. Even a random initial scattering will yield local concentrations of similar items that stimulate ants to drop other similar items. As concentrations grow, they tend to retain current members and attract new ones. The stochastic nature of the pick-up and drop behaviors enables multiple concentrations to merge, since ants occasionally pick up items from one existing concentration and transport them to another. The speed of this process depends on the size of the ant population available, which in the case of digital ants can be scaled by adding more computational power, and its dynamics can be characterized to provide reliable performance estimates. For example, [4] shows that the size of clusters is concave as a function of time, with a rapid initial increase and slower long-term growth, providing good any-time response. Figure shows the progress of 20 ants on this sorting activity, given 200 instances of each of two types of object in an 80×80 field. Even with this small population of ants, useful clusters form after 50K cycles. Assuming 500 machine instructions per ant cycle, 20 ants per processor, and a 1 GHz processor, this level of sorting takes only about half a second.

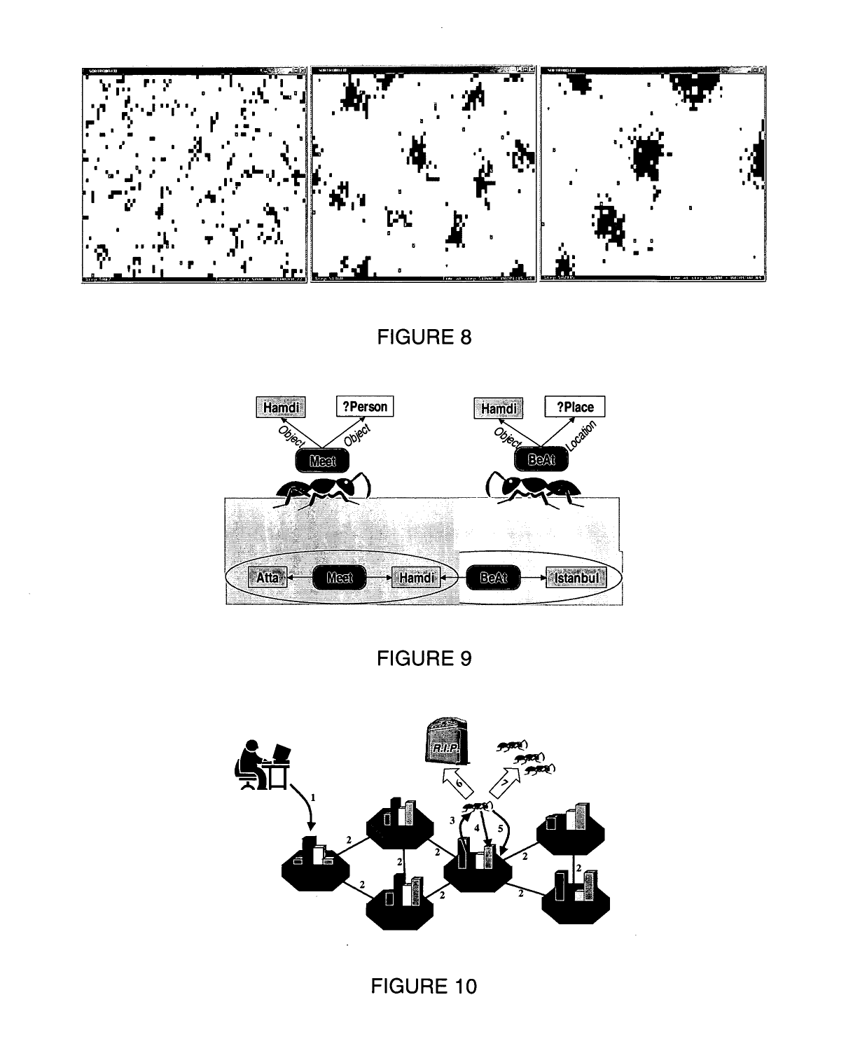

In engineering applications of this algorithm, movement in the “nest” is actually an abstract distance metric among documents. When an ant picks up a document, moves it, and drops it, the document's location in the distance metric actually changes. The ants in FIG. 8 must cross large unoccupied regions. Our topology avoids this time-consuming feature. We expect to demonstrate ant populations in the thousands (on the order of 1% to 5% of the number of documents), and the architecture can accommodate much larger populations by adding processors.

A variety of this algorithm, using a distance metric on document keyword vectors, has been used successfully to sort documents from the web [11], and we will adapt this approach to find subsets of documents in a massive data store that share relevant features. “Relevant” is defined by the distance metric applied by the individual ant. CAFÉ will adjust this metric, in response to analyst feedback. For example, depending on this feedback, the sorting criterion might be references to a given individual or organization, or to a given region of the world. (We will use a version of WordNet [15], most likely the enhanced Applied Semantics CIRCA, Conceptual Information Retrieval and Communication Architecture [2], to resolve homonyms and synonyms in support of clustering.) The underlying intuition is that subsequent analysis, whether machine-based or human, will be more efficient if documents are initially grouped in a meaningful way. Because we will manipulate pointers to documents rather than the documents themselves, a document may be sorted into multiple locations.

Natural ants do not use pheromones for clustering. (though they do for other purposes). Ant CAFÉ's clustering ants will use different pheromone flavors to “sign” the documents that they manipulate to indicate the analyst whose profiles they represent. Thus the system can support multiple analysts or groups of analysts at the same time, and the clustering algorithm can take this signature into account so that clustering can reflect not only the contents of the documents but also the interest of a particular analyst. The evaporation rate of the “signing” pheromone can be adjusted to permit analyst-dependent clusters to dissolve if the ants that are building them die off (reflecting a change in analyst interest away from the categories they represent).

Structure ants focus their attention on one or a few of the piles thus generated. This presorting increases their efficiency. They search for case and event structures in the assembled documents. Each ant embodies a schematic linguistic structure, such as a case frame (a verb or verb class and a partially qualified set of slot fillers) or discourse frame (paragraph type with slots described in terms of completed case frames and connectives). Thus a given structure ant might be searching for meetings, or for meetings involving a particular person, or for meetings followed by explosions, etc. The structural schema is initialized on the basis of the analyst's profile to match structures of interest to the analyst. During ant evolution, mutations can alter these schemata to construct templates that could discover unanticipated structures. To recognize case frames, structure ants will use simple text recognition techniques such as collocation of diagnostic lexical items within a specified distance of one another. We will construct structure ants around a preexisting commercial grammar analysis engine such as WGrammar [33]. Structure ants have similar dynamics to clustering ants, and their population will also be measured in hundreds, scalable upwards by adding processors.

Structure ants live on a graph whose nodes are named entities in the domain (e.g., people, organizations, locations), and whose links are case and discourse links relating these entities to detected case frames. For example, one ant might be searching for meetings involving Yaser Hamdi, while another tracks his movements.

FIG. 9 shows how success by the two ants leads to an instantiated case graph unified on Hamdi. This graph is a network of instantiated case frames, and thus embodies the hypotheses currently under consideration by the system. Structure ants deposit pheromones on this graph and on the documents in which they find matches.

Structure ants do not do any deep linguistic analysis of natural language texts. They identify potential matches with their schemata based on simple pattern-matching (with synonyms and homonyms resolved by CIRCA). In isolation, these mechanisms may sometimes result in false negatives or false positives. These limitations do not invalidate Ant CAFÉ, for two reasons:
1) The pheromone mechanism insures that an individual ant's opinion is relevant only if reinforced by other ants. Differences among individual ants such as the documents they have encountered means that some will see things that others miss. The system registers a hypothesis only when many individual ants concur. The danger of false negatives is further reduced by the preliminary clustering activity that gathers many documents on the same topic. A description of an important event that is not easily extracted from one document may be more clearly accessed in another. Because the documents are grouped together, the swarm of ants processes them together, and can integrate insights available from each; and
2) The purpose of Ant CAFÉ is not to replace the analyst, but to draw the human's attention to subsets of data that may be worthy of further scrutiny, and that might otherwise be overlooked in the mass of data. Ultimately, we rely on humans to do intelligent analysis for which they are uniquely suited.
   Digital Pheromones

Both clustering and structure ants deposit and sense digital pheromones, with five functions.

1. Pheromones on regions of the graph indicate the strength of the associated hypotheses. High pheromone concentrations draw the attention of analysts to the associated case frames and the underlying documents. The resulting pheromone strength depends on the frequency of deposits (how many ants substantiate them), the recency of deposits (since pheromones evaporate over time), and the amount of deposits. Thus an ant whose schema describes an imminent terrorist attack might make much larger deposits than one searching for background information on drug smugglers, so that the more critical a scenario is, the sooner it is brought to the analysts' attention.

2. Pheromone signatures can be traced to particular analysts. These signatures permit one Ant Hill to support multiple concurrent analysts, and also allow both structure and clustering ants to take into account the analysts who are interested in a given construct as input to higher-level pattern detection.

3. Pheromones left by lower-level structure ants (detecting case frames) identify the kinds of propositions detected, and furnish the raw material for higher-level structure ants (detecting discourse structures).

4. Clustering ants can key on the pheromones deposited by structure ants. These clusters in turn form enriched search spaces for yet higher-level structure ants. Thus the two species form a synthetic ecosystem whose power comes from the interactions not just of individual ants but also of populations.

5. Pheromones evaporate over time, forgetting information that is not reinforced. Thus the system automatically purges itself of obsolete information and dead-ends that analysts have chosen not to pursue.

Ant Life Cycle

The life cycle of individual ants is crucial in the functioning of Ant CAFÉ. This life cycle includes birth, reinforcement, reproduction, and death.

Ants are born at a constant rate with a fixed life span. Thus the population size (≈computational load) is constant, while the composition can change. Two mechanisms spawn new ants.

First, analyst profiles generate ants bearing schemata that are fragments of the templates in the analysts' profiles. As these profiles change, so do the schemata active in the population. If other researchers provide us with metastrategies, transitions based on prominent hypotheses can anticipate shifts in the analysts' priorities-and change the ant population accordingly.

Second, at regular intervals a fraction of the active ants reproduce, an action that combines active schemata while introducing some stochastic mutation. The ants chosen to reproduce are those whose products analysts have rewarded most strongly, again ensuring that the population tracks current analytical priorities.

Human-Information Interface

To support the Ant CAFÉ's interaction model of computation, analysts interact with the ant swarm as outlined in Figure. Broadly speaking, two types of interaction are supported. First, the system engages the analyst in a preliminary dialogue to determine initial profile and strategy. Second, the system's search activity can be guided by the analyst.

The analyst guides the behavior of the system in two ways. First, the system's behavior can be controlled by modifying the explicit analyst profile created by AME. This results in new search templates being created and thus changes the Ant Hill's behavior. We refer to this guidance as indirect, since the ants are being rewarded indirectly. Alternatively, the ants can be rewarded directly by the analyst's review of the patterns the Ant Hill detects. This interaction is more complex than the others just described, and we spend the remainder of this section outlining the process.

Analysts respond to three different products of ant activity.

First, when a cluster formed by the clustering ants reaches a critical size, the analyst is notified of its existence and the set of keywords that characterize its contents.

Second, when pheromone strength on a region of the linguistic graph being constructed by the structure ants passes a critical level, that fragment of the graph is presented to the analyst. Recall that pheromone strength reflects both the criticality of the discovered structure and the degree of reinforcement from multiple ants, so that weakly attested but potentially highly critical information is surfaced for human review. Appropriate displays are highly intuitive and compress a great deal of information into limited space. JFACC operated in a geographical domain, so the underlying topology in FIG. 10 is geographical. Such a display would be appropriate in Ant CAFÉ if one were doing location-based clustering and wanted to see regions for which strong clusters of documents existed. For structure ants, the underlying topology of the display would be a linguistic graph rather than a map.

Third, strong hypotheses discovered by ants are fed back to the analyst's profile, which is visible to the analyst

In each case the analyst has access to the underlying documents. The analyst evaluates these products and their underlying documents, and the Ant CAFÉ propagates these rewards to the ants responsible for them. These ants in turn may be building oh the results of lower-level ants. The output of such an ecosystem depends on all links in the chain, not just the link that produces the final pheromone leading to the display that the analyst sees. We have developed a bucket-brigade system that propagates credit from the analyst down through the food chain so that the entire ecosystem is reinforced as appropriate (FIG. 12).

### Constructive Plan

Our constructive plan for implementing Ant CAFÉ combines early demonstration of the key technical components with a continuous integration process that yields a system with growing functionality over the course of the program. The specific tasks are described in the Statement of Work (Section 6) and the timing of those tasks is laid out in the Proposed Period of Performance (9). By the end of the first nine months, we will have stand-alone functioning demonstrations of the major components of the system, and definitions of the interfaces among them. Over the rest of the project, we will integrate them into successively larger units.

Interfaces

The components of Ant CAFÉ will interact through XML streams. This approach is simpler and more robust than direct API's among components, and facilitates system debugging through examination of intermediate data. A stream-based interface is slower than API's, but it is the safest way to demonstrate the system's functionality, and could be replaced with direct API's in Phase II of the program.

Components

FIG. 1 shows the major components of the system. The following paragraphs discuss the constructive plan for each of these units, and our approach to the base-option structure of the program.

AME.—The first step is a formal analysis document defining analyst activity. This document enables the implementation of the activity stack, which becomes the foundation for developing analyst profiles using both conventional and swarming techniques. The profile content (class, value, and weight) and the content of the analyst activity stack will be visible to analysts. Because we maintain the history of the profile adaptation over time, the analysts may view their profile histories to better understand the drifts in their interests and approaches and consider whether such drift was intentional or unintended (perhaps due to exploration of “red herrings” or to some other distraction). Since the profile representation is readily interpretable, AME allows the analyst to modify their profiles to reflect their actual interests better (FIG. 1).

Ant Hill.—The two species of ants can be developed in parallel. Development of the clustering ants will be straightforward, and will be an early demonstration of the capabilities of stigmergic data mining. Development of the structure ants will require a preliminary formal analysis document detailing the case grammatical model we will use, and will draw on a commercially available grammar engine to recognize case schemata. In both cases the initial ants will be hand-tuned to support stand-alone demos of data clustering and case frame construction, and to support early analyses of the capability of these mechanisms. Subsequently, we will develop the evolutionary environment for automating their tuning on the basis of rewards from the analyst.

Data Haystack.—This subsystem includes the pheromone infrastructure that supports the operation of the ants, as well as basic utility functions, including document identification, storage, and retrieval, and information retrieval code for keyword extraction and stemming. In our experimental environment, this subsystem will be a database fed by a simple spider drawing on newsfeeds on the web.

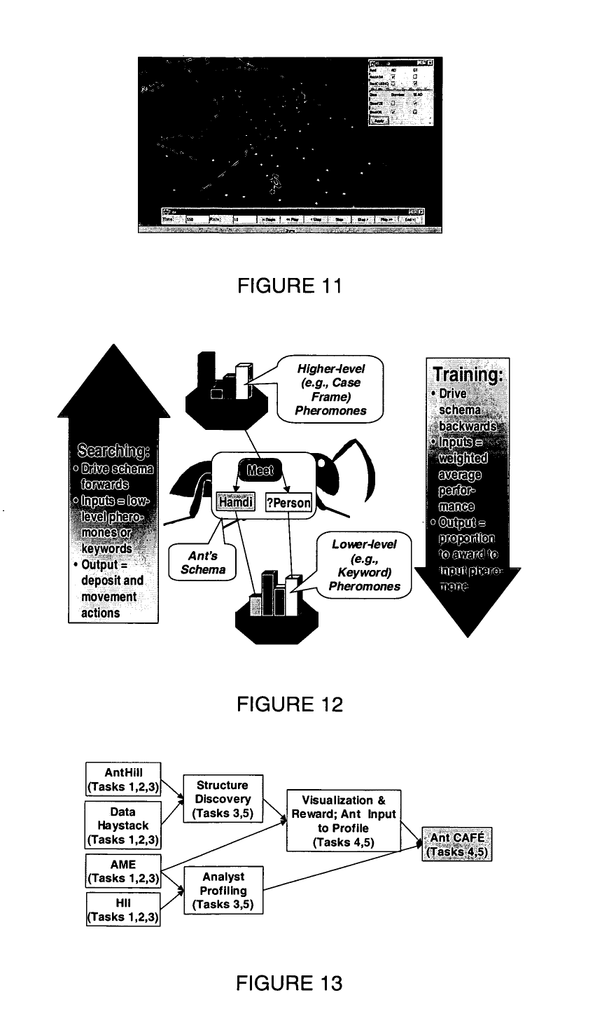

HII.—Each component will develop its own user interaction requirements. A separate activity will define the overall architecture and look and feel for the HII, and will implement displays and dialogs to support each of the other components. For stand-alone demonstration, the HII will provide a GUI for viewing and modifying analyst profiles (both individual and group) and a form-like dialog for initializing the profiles. The feedback to the AME can be in the form of XML files, Excel files, or Access database files. The visualization of the pheromone deposits will use the techniques already developed in our team's work on the DARPA JFACC program (FIG. 11). Emergent hypotheses will be displayed as an alert message generated using case grammar representation. The positive and negative reinforcement of the digital ants by the analysts will be controlled through the modification of parameters in the analyst profile that are specific to reinforcements of the ants. As these parameters are modified, the changes in turn will modify the programs that guide the behavior of the ants.

Base-Option Approach.—As outlined in (Section 6), the base period of the project will yield a fully integrated Ant CAFÉ whose components have limited adaptability, to demonstrate the capabilities of the overall architecture. The option period will increase the adaptability of the components and conduct further experiments to optimize system performance.

Module Integration is depicted in FIG. 13, which includes:
Integration of the Ant Hill with the Data Haystack will provide a self-contained ant-based document management system.
Integration of the AME with the HII will permit demonstration of analyst profiling.
Separate integration of the AME with the Ant Hill and Data Haystack supports visualization of results and feedback to guide ant evolution.

Final integration connects the analyst profile to the Ant Hill to guide the generation of new subspecies of ants.

TABLE 3
Risk Analysis

| Risk | Mitigation Strategy |
|---|---|
| Potential combinations of | Swarming processes stochastically explore space of |
| relevant features overwhelm | combinations |
| conventional search | Pheromones and preferential reproduction favor useful |
| mechanisms. | combinations |
| It may be difficult to | We draw on extensive experience by ourselves and others |
| implement suggestive insect | applying these metaphors to computational systems. This |
| behaviors in an engineered | experience includes interfacing swarming with more |
| system, and to integrate | procedural systems (for example, in industrial work, |
| these mechanisms with | integrating swarming factory scheduling systems with |
| procedural computation. | conventional databases and other information |
| | management tools). |
| The analyst may be | Interactions are at the domain level (evaluating patterns |
| overloaded by the need to | proposed by the system), not the level of ants and |
| interact continually with the | pheromones. |
| system. | In profile construction, explicit queries are minimized in |
| | favor of observing behavior. |
| | Interaction increases the system's inductive power, thus |
| | reducing the amount of irrelevant material that the analyst |
| | must review. |
| Ant convergence time to | We have a range of ant tuning mechanisms (spawning, |
| produce useful patterns may | reward, reproduction) available to influence this time, |
| be too slow | trading analyst interaction against convergence time. |
| Our system may not support | We have in-house expertise in intelligence analysis (Snyder |
| real world analyst behavior | at Sarnoff, Cors at Altarum) to guide us in this effort. |
| The analyst model being | We have successfully developed a profile-based database |
| created will not be sufficient | search function in another problem domain. We believe |
| to guide search behavior | we can extend our approach to the intelligence domain. |
| The profile adaptation | We will use our Profile Workbench to study the behavior of |
| algorithms may converge | adaptation algorithms and optimize them to achieve better |
| slowly or result in | performance. This approach has already been |
| inadequate profiles | demonstrated in another problem domain |

Interactions with the Glass Box Environment and Use Of Data

We expect that the GBAE will capture (at least) these types of analyst activity information:
Data items examined, with the ones deemed to be of interest appropriately tagged.
Analyst strategies, in the form of information source preferences, level of trust in the various sources, etc.
Analyst scenarios and hypotheses. The specific data structure of these information types needs to be specified early on in the program.

Most importantly, we expect that at least some of the data items that the analyst has examined will also be processed by the GBA. For example, if the analyst listens to an audio broadcast, we would prefer to receive a transcript and not be forced to process the audio ourselves. While our team has the technical capability to process video, audio, image, and other types of information, such processing does not highlight the major innovations of Ant CAFÉ, and we do not propose substantial effort in this area. We expect to do standard textual processing but no complex multimedia processing.

We expect to submit to the GBAE information that our system has created based on GBAE information plus information mined from the Data Haystack (see FIG. 1, Notional Architecture). We plan on adding to the GBAE knowledge base at lest the following items.
Analyst Profile and Analyst Activity Stack
Newly formed hypotheses that the Ant Hill estimates to fit the analyst's profile
Pheromone levels generated by the Ant Hill

We expect to be able to interact with the GBAE in either of the following two ways:
A programmatic interface: An API exists, and our software can initiate a procedure call on-the GBAE system. This is a more interactive mechanism than the one below. We would expect to be able to send data to the GBAE using the same mechanism.
A log-based interface: The GBAE periodically produces a log or a file-like data structure. Our system periodically reads and processes such a log, and also create a similar log or file for the GBAE to process and add to its repository.

In either of these two approaches we would expect the data being exchanged to also include meta-data, e.g., XML tags.

Whether part of the GBAE or not, we expect to be able to interact briefly with the analyst at the beginning of his work. This initial dialogue, consisting of menu-like selections, will initialize the analyst profile. We also expect to show our analyst model information (especially the Analyst Profile) to the individual analysts, either directly or (preferably) via the GBAE, and solicit modifications if necessary. These modifications should also be captured by the GBAE.

A Narrative Scenario

Maria is an intelligence analyst tasked with assessing threats against US nationals living or traveling in the Middle East. Her job is extremely demanding, not only due to its importance but also because of the massive amounts of information she must sift every day. Her primary source of data is a vast repository containing text and multimedia documents from both open and classified sources. She can query the repository by entering a sequence of keywords. Before Maria became experienced, her choice of keywords produced mixed results, but now she can obtain mostly useful documents. Maria mostly employs her usual set of keywords. Through practice, she has learned that this set selects roughly enough documents to keep her occupied all day and no more. Of course, she has no way of knowing how many potentially useful documents she misses. Maria realizes that her interests shift over time as she explores new hypotheses, but she does not have a principled method for tuning her keywords, so she keeps it relatively static. Although she does not realize it, she has a systemic bias against video. She is not a visual person and prefers to read rather than watch. Maria is proud of her many top-notch colleagues. She would like to use their expertise in areas where she is less experienced. However, she does not know their current focus areas, and feels uncomfortable taking up too much of their time.

Today, Maria is using a new intelligence analysis tool called the Ant CAFÉ. Maria is not an expert in user profiling or emergent behavior agents, nor is she aware of any of the underlying technology of the system. She receives no specific training in the use of the system and simply sits down to use it.

Maria begins with the Ant CAFÉ's Analyst Modeling Environment. The system offers her a menu of standard initial profiles, as well as one that her supervisor considers reasonable for her job. Maria chooses a third option, engaging the system in question-and-answer. This task is easy for Maria, since she already has experience with her “usual” keyword set (area_of_interest=“Middle East”, terrorist_name=“Bin Laden”, etc.). The system asks about the importance of each keyword, and she makes an educated guess as to their relative weights. Next, AME presents her with a list of keywords (e.g., job_title=“oil executive”) that were implicit in her searches, but she had not employed them explicitly. She is unsure about their relative weights, and lets the system choose default weights. The “interview” is now over, having taken about half an hour.

Maria now goes back to her usual routine. She looks for the terrorist activity pattern in which she is normally interested: two or more terrorists in the Middle East that have been suspected of violence in the past and that have recently mentioned the name of an American citizen in a conversation. Maria informs Ant CAFÉ of her search strategy via a simple CAD-like interface, and her usual keywords and starts examining the documents retrieved.

Almost immediately, the Ant CAFÉ's notifies her that it has found several potentially interesting documents. Some were also retrieved by her usual keywords, others are not relevant (and she informs the system of this), and yet others seem to be new to her. Several of the documents the system found happen to be Al Jazeera clips. She has always ignored these in the past, but these clips seem worth viewing.

Maria is surprised that, although the system is looking at a far greater number of documents than she can, she is not being overwhelmed by a torrent of information. Because the Ant CAFÉ is looking for higher level patterns, documents that merely match her keywords are not always immediately shown.

A second surprise awaits her. She is shown a document containing a list of visitors to a kibbutz. There is no mention that they are American citizens. She then remembers a fellow analyst mentioning that this particular kibbutz receives many guests from New York. The system has clearly acquired her colleague's prior knowledge, and the AntHill retrieved this document not because of Maria's profile, but because of the profile of another analyst who shares her mission.

At this point, Maria decides to use the Ant CAFÉ Human-Information Interface to examine her own model. She sees her profile and notices that several weights have now changed, and correctly so, since her interests had shifted over the last several hours. She decides to refine one of the parameters. Maria also looks at the Analyst Activity Stack and notices that one of the hypotheses of which she feels confident is marked as being formed too early. Just in case, she decides to look for more supporting data before completing her product, a report to her supervisor.

Maria is excited about her new tool. At a minimal cost in time, she was able to have the system examine much more data than she could on her own, yet she was not overwhelmed with irrelevant documents. Her biases did not stop her from examining any sources, and she was able to use a colleague's experience without his ever knowing he was helping. Maria plans to learn how to reinforce the Ant Hill's products directly and obtain even more value from the Ant CAFÉ.

Integration Plan

Integrating the MKB with a program-wide data repository may be important. Table 4 summarizes our approach.

TABLE 4
Integration Approach.

| System or sub-system | Principal Interface mechanism |
|---|---|
| Ant CAFÉ | through GBAE |
| AME | XML |
| Ant Hill | input: XML |
| | output: through GBAE |
| MKB | SQL export |

Ant CAFÉ work does not address Technical Area 2. One way to integrate the work of other teams in this area is to precede the GBA information stream by the actions of a “virtual analyst” whose job it is to “discover” prior and tacit knowledge. Thus, from our perspective, these types of knowledge do not differ from others.

Ant CAFÉ.—The overall system interfaces with the GBA through the HII (FIG. 1). The specific details of the integration depend on the architecture of the GBAE, which is not yet fully specified. We expect one of two alternatives. In a programmatic or API interface, our software can initiate a procedure call on a GBAE server. In a log-based interface, the GBAE exchanges files (e.g., logs) with our system. In either case, our system will both obtain data from the GBAE and export information to it. E.g., the AME-generated profile and the pheromone levels of the Ant Hill will be exported to the GBAE so that other research teams may use the information we have generated. Integration of the Ant CAFÉ with other NIMD environments will be straightforward as long as such environments provide a similar interface to that of the GBAE.

AME.—The Analyst Modeling Environment will generate both an Analyst Profile and an Analyst Activity Stack. The information in both of these data structures will be available to our HII via an XML-tagged file. That same interface may be employed by other research teams to query the AME system and obtain the information it has gathered.

Ant Hill.—The Ant Hill is controlled via a reward mechanism that motivates the digital ants. Other research teams can exercise the ants by the same technique. The actual data input is done via an XML-tagged file. The output of the Ant Hill is stored in the Data Haystack, which is part of the GBAE (FIG. 1). Other teams can obtain the generated information from the GBAE itself. In other NJMD platforms, we expect that some global repository will exist taking the place of the GBAE; thus, other teams can obtain the Ant Hill data from said repository.

MKB.—Integration with the Modeler Knowledge Base is straightforward in all cases. We expect to use a COTS DBMS (very likely, a freeware DBMS such as PostgresQL [23]. Hence, our knowledge base will share its data with either the GBAE or another NIMD platform as long as either one has a repository supporting SQL export mechanisms. Alternatively, it will be simple to discard our DBMS software and move our data to any NINM repository as long as the repository supports a programmatic SQL interface.

### Processing Architecture

This portion of the disclosure describes how the Ant CAFÉ ant hill will gather evidence to instantiate investigation profiles. The primary focus is on processing rather than the component architecture or development strategy.

Inputs

The following list includes inputs to the ant hill specific to an investigation. Concept maps will be passed to the ant hill from a profile adaptation module.

1. A concept map. Concept maps include a set of relations (R A B) connected into a graph. The nodes are ontology concepts (A, B) and the edges are ontology relations (R).⁵ For some relations, one concept and/or the ontology relation may be vacuous: e.g. Thing, and/or Related, respectively. A weight in the interval [0, 1] will be associated with each relation that describes the relative importance of that relation.
⁵I apologize for overloading the term “relation” to refer either to the tuple (R A B), or to R within the tuple.

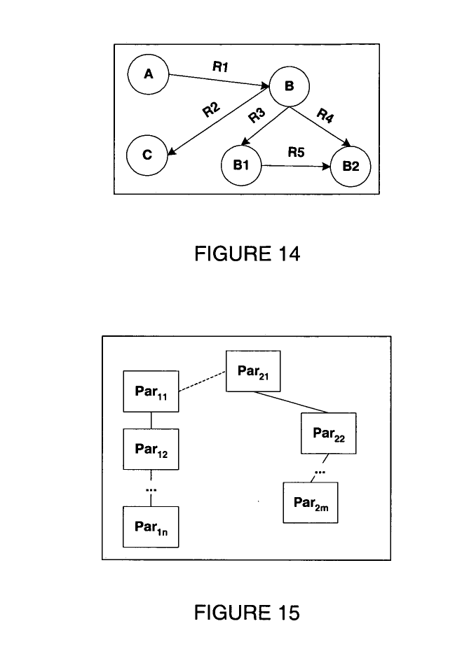

Figure illustrates a concept map that is abstract, and unrealistically small. The only content suggested in FIG. 14 is that B1 and B2 are part of the ontology definition for B, while A, B, and C are distinct ontology concepts that are hypothesized to be related by the analyst.

Concept maps are an alternative representation of the investigation profiles: or, perhaps, a superset of the investigation profile, if we determine that it is beneficial to use larger concept maps for gathering evidence than are suitable for profile learning.

2. Msets and procedural recognizers. Manifestation sets (msets) are lists of words that identify how a concept might manifest in a text document. They are equivalent to WordNet synsets. For example, the mset {sofa: couch, sofa} might indicate that the ontology concept Sofa could display in the text as either “sofa” or “couch”.

Every concept and relation will have either an mset or a procedural recognizer. For example, email addresses can be recognized based on the @ sign, but cannot be enumerated.

3. Text patterns. Typical Information Extraction (IE) systems use linguistically-oriented regular expressions to recognize relations in text. For example, an IE system desired to extract evidence of personnel changes from news stories might include patterns such as person retires as position person is succeeded by person where person and position are members of msets or procedural recognizers and the other terms are must be matched exactly in the text.

An example of a text pattern that might be used by the ant hill is shown below, where grammatical constructs are identified in square brackets [] and mset/procedural recognizer substitutions are in angle brackets <>.
<[NP]B1>, <[VP]R5>[PP]<[NP]B2>

The task of generating text patterns given a desired output template is a non-trivial knowledge acquisition task that is the major bottleneck impeding widespread adaptation of IE technology. Researchers are currently developing a variety of approaches for automatically or semi-automatically developing patterns, including generation from meta-rules (Grishman 1997), and machine learning from examples (Soderland 1999).

The Ant Hill will need to use either regular expression text patterns, or an equivalent mechanism (for example, we should research Rich Rohwer's Bayesian approach). This will not be a research objective for us, however. Our implementation approach will be to use some available technique, and to supplement it with enough personal attention to achieve patterns that yield attractive demos.

On the other hand, our approach will recontextualize the information extraction problem in a manner that challenges that community: namely, by using the ontology to dynamically generate concept maps, which are functionally equivalent in this context to IE templates.

4. Documents, indexed on the paragraph level of granularity (with each paragraph indexed as a separate sub-document). This level of indexing will be necessary because the relations that we need to recognize in documents will often be unrepresentative of the full documents that contain them.

The documents should also be preprocessed to identify basic grammatical constituents such as noun phrases and verb phrases. We should also apply rudimentary algorithms for resolving pronoun references (for example, substitute the previous mentioned person for “he” or “she”) and similar linguistic phenomena that have a significant presence in the test.

Outputs

The ant hill will output evidence that associates documents with relations in the concept map. The ant hill will build structures that represent, simultaneously, the numerous ways in which relatively abstract concept maps are instantiated in document evidence. Therefore, we will be able to extract from these structures output that is designed to meet the needs of the investigation feedback loop.

In particular, for each input concept map relation, the ant hill will be able to produce a set of evidence relations where each evidence relation includes:
A reference to a paragraph, the paragraph's document, and the document's metadata
The pattern used to match the concept map relation, and the terms in the document text that were matched to the pattern
The terms in the text that match to the concept map concepts and relations.
These terms will be as specific or more specific than the corresponding concepts and relations in the concept map. For example, if the concept map includes a node for a Person, the evidence relation might specify that the person is Mr. George Smith.
A quantitative strength that estimates the system's confidence in the evidence relation. This estimate will not reflect the goodness of fit to the matched pattern.

Rather, the strength estimate will reflect the degree to which the evidence relation fits with other evidence into the larger pattern defined by the concept map.

Stages of Processing

Ant hill processing will be divided into three conceptually distinct stages, each of which is described in a section below. The first stage will organize text into a paragraph matrix—a clustered space—that supports efficient exploration in the second stage. The second stage will match text patterns associated with the relations in the concept map to identify evidence relations. In the third stage, evidence relations will self-organize into evidence structures.

Regarding temporal execution, identifying evidence relations will be most efficient if it starts after completion of the paragraph matrix. There does not currently seem to be any reason to delay the third stage once the second has begun, however, since evidence relations can start to self-organize as soon as they are created.

The Paragraph Matrix

Ants “carry” objects from place to place, “picking up” objects with probabilities that increase with dissimilarity between the object and neighboring objects, and “dropping” objects with probabilities that increase with similarity to neighboring objects (Camazine, Deneubourg et al. 2001). This results in increasingly homogeneous neighborhoods.

The first stage of processing will involve a clustering process that will be similar to the demo except in the following aspects:
Clustering will occur on the level of paragraphs rather than whole documents.
This will be appropriate given our expectations that frequently evidence will be gathered from possibly isolated references within multiple documents.
Clustering will occur for each investigation, where contributing paragraphs have been filtered from the massive data based on the occurrence (to some degree) with concepts in the initial investigation profile. (Alternatively, perhaps it would make more sense to filter on the document level, then cluster paragraphs within those documents?).
The similarity metric will be based on co-occurrence of msets in the concept map.

FIG. 15 illustrates a fragment of the paragraph matrix produced by clustering. The figure shows links between paragraphs in the same document and between “similar” paragraphs in other documents (the first subscript references the document, the second the paragraph in the document). More precisely, the matrix will provide a set of probabilities that ants will use to decide which paragraph to inspect next. Paragraphs within the same document will be treated as being to some degree similar, even if they are not clustered together closely according to mset co-occurrence.

Evidence Relations

In the second stage of processing, ants will match text patterns associated with concept map relations against text in the paragraph matrix. Every ant will search for evidence of a single concept map relation using all of the text patterns associated with the concept map relation. Every pattern match will create a new evidence relation, which will participate in the processing described in the next section below.

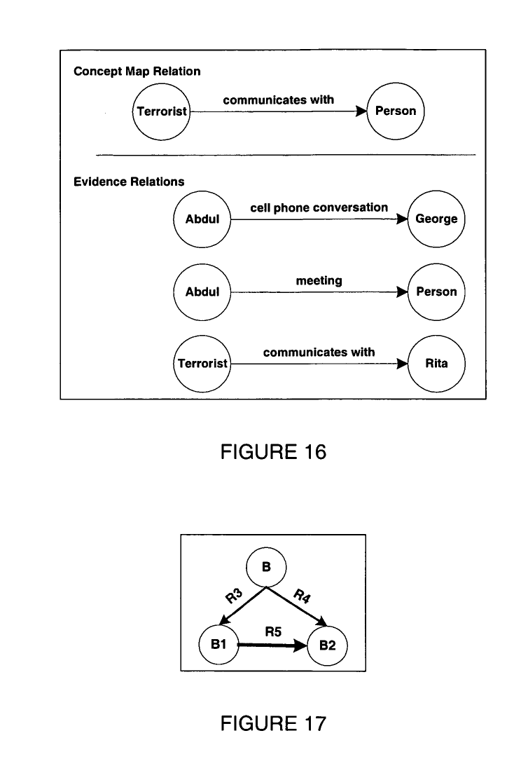

FIG. 16 shows several evidence relations associated with a concept map relation. The concept map relation must be matched in the text with words associated with ontology concepts or relations that are at least as specific as the corresponding elements of the concept map relation.

A recruiting mechanism analogous to ant or bee foraging will be used to channel attention to relevant areas of the paragraph matrix. When these insects return from a food source, they decide based on the richness of the source and its proximity whether to expend some effort to recruit other insects to forage at the same location. Bees recruit by conveying information about the source with a public dance. Ants recruit by moving among other ants and touching antennas.

In our ant hill, pattern matching ants will die and there will be a constant flow of new ants spawned. When an ant is successful in creating evidence relations from a paragraph, it will “deposit pheromones” that increase the probability that ants for neighboring relations in the concept map will visit that paragraph. (Since ants deploy all patterns, there is no point in encouraging other ants for the same concept map relation to visit the same paragraph). The pheromones will evaporate as usual, so that the stability of the increase of attractiveness of a paragraph and, indirectly, its neighbors, will depend on sustained success.

Ants not yet at the end of their lifetimes must also choose the next paragraph to visit. Perhaps the expected proximity of the next paragraph will depend on the degree to which they have been recently experiencing success.

Evidence Structures

Typically, evidence will be found for many different instantiations of the concept map. The number of possible alternative instantiations is huge, since each concept map relation can be instantiated in many ways and there is a combinatorial number of ways for composing these evidence relations.

Furthermore, the evidence relations will unavoidably contain substantial noise caused by faulty text patterns. This will especially be true given the ad hoc nature of the text pattern generation that will be implemented for early versions of the system.

The ant hill will use self-organization to produce evidence structures that consist of mutually compatible evidence relations connected to each other according to the template provided by the concept map. The basic idea is to agentize evidence structures (where an evidence relation is a minimal structure), organize a space in which they encounter other evidence structures, and then answer the question “Do I fit here?”⁶
⁶The metaphor to ants is not quite appropriate for this stage of processing, which seems most similar to molecular self-assembly.

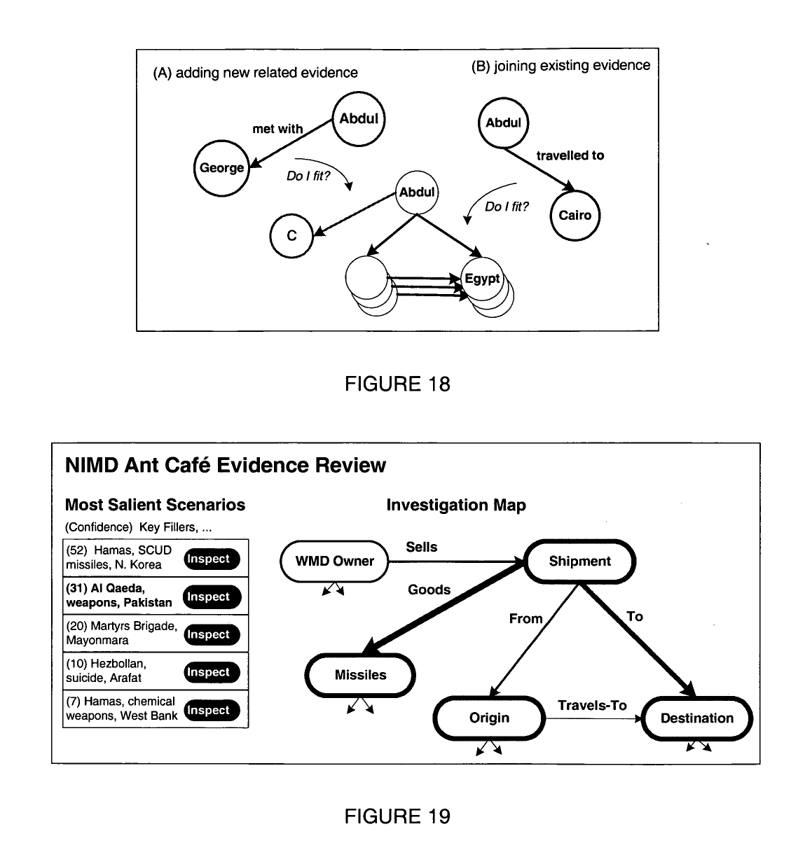

FIG. 18 illustrates two kinds of “join” decisions. In the type A decision, a single-element evidence structure (red) is considering joining an evidence structure to fill a slot is currently vacant (colored in gray). This will depend on compatibility of the shared node. In the type B decision, a single-relation evidence structure (blue) is considering joining a structure where the slot is already filled. If both concepts and the relation are compatible, the new evidence can join the structure and thereby increase the confidence of the system in the evidence for the reinforced relation. An evidence structure containing multiple relations may also consider joining another multiple-relation evidence structure.

Clearly, to produce self-organization of evidence structures with high fidelity to the real world would require a rich variety of operations to model various complexities. This will not be in scope for our current effort. In future research, we could elaborate the system to handle a variety of situations. For example, Abdul might also be known by a number of aliases. Recognizing aliases is a non-trivial problem that is the subject of significant research on its own, for example, in the context of fraud detection. Our system could handle this complexity in several ways. In future research, we could relax the operationalization of compatibility in certain contexts. For example, if we assume that most aliases will maintain the gender and ethnicity of the person, we could allow names of the same gender and ethnicity to be considered compatible. We could also model aliases by permitting alias relations to attach to evidence structures under certain conditions. This sort of structural modification might be appropriate if the system were also doing a variety of other types of reasoning—using the ontology and other available knowledge sources—to construct and manipulate the evidence.

Quantifying compatibility between ontological structures is a tricky research issue, but several types of algorithm have been developed. Most algorithms for judging compatibility are intensional, in the sense that they compare the structure of concept definitions and look for overlap and/or correspondence (Weinstein 1999). When a corpus is available, algorithms of an extensional nature may also apply. For example, one might estimate the compatibility of two terms by calculating the information-theory entropy of their least common subsumer (Smeaton 1999).

Compatibility algorithms will be useful to the ant hill both for judging compatibility among evidence relations, and for organizing the space of evidence structures. In other words, evidence structures must choose other evidence structures to judge their fit. While, for example, it would be possible to move the evidence structures randomly about a k-dimensional space, it will be much more efficient to choose evidence structures to compare against that are likely to be good fits.

One important challenge will be to develop comparisons where a new evidence structure can replace existing structure in order to provide better overall coherence (the expelled structure elements can then wander the space on their own looking to join other structures). With such a replacement mechanism, we will then be able to characterize the self-organization as optimization.

Embedding in the Investigation Feedback Loop

Search in the ant hill is tied very closely to the investigation profile. First, evidence relations are materialized in correspondence with particular relations in the concept map (which is equivalent to the profile or at least to some overlapping part of the profile). Second, the number of ants searching for evidence of each relation can be calibrated according to the current weights in the profile.

There are two ways to design the weighting effect. The size of the population of ants searching for each concept map relation can be proportional to the weights. Alternatively, the longevity of ants searching for each relation can be proportional to the weights. In either case, ants expire and there is a continual spawning of new ants. This means that as profile weights are adjusted, the number of ants searching for each relation will also change.

On the output side, the most substantial evidence structures will be selected as the basis of the ant hill's answers to the analyst interface. Intuitively, the coherence of graphs of evidence relations should add confidence that each member relation is accurate. Also, the reinforcement of evidence relations matched from difference sources should also boost confidence.

A certain amount of post-processing will be required to transform ant hill output into the correct form for viewing by analysts. For example, analysts may want to browse documents, not paragraphs. In this case, evidence accumulated on the paragraph level will need to be aggregated.

Summarizing thus far, an important contribution of this invention is to divide processing to recognize relations into three distinct stages that each have well-defined inputs and outputs. Recognizing relations in documents is a very challenging task. We consider the processing described in this document to be a form of “poor man's natural language processing”. The architecture described in this document turns a very challenging task into three tasks that are each less intimidating than the whole.

Swarm intelligence plays a vital role at each stage. The main benefits for the first two stages—producing the paragraph matrix and evidence relations—will be to enable processing to occur in a decentralized and highly parallel manner. The building of evidence structures, meanwhile, is completely dependent on swarming: it is not clear how one could otherwise represent, simultaneously, a combinatorial number of alternative possible instantiations with the hope of producing near-optimal results.

### A “Hypothetical” User Interface

Explaining the Ant CAFÉ investigation cycle may prove to be challenging. The notion of corroborating hypotheses with alternative instantiations is somewhat abstract. For this purpose, this memo portrays what the Ant CAFÉ user interface might look like.

FIG. 19 illustrates a screen for reviewing evidence identified and assimilated by the ant hill to match concept maps. The main ingredients include the concept map (here termed “investigation map” to be closer to the analysts' way of thinking), and a list of the most substantial evidence structures constructed, here called “most salient scenarios”. The scenarios are identified along with a gestalt quantification of confidence, and a few cluster-identifying instantiating terms associated with the key concepts in the investigation profile (those identified by the analyst). When the user selects one of the scenarios, those relations in the investigation map that are covered in the evidence structure change color. The thickness of the edges shows the strength of the evidence for that relation (we could also show profile weights in this manner). Clicking on the small arrows underneath some of the map nodes drills down to look at relations that constitute more detailed levels of the map.

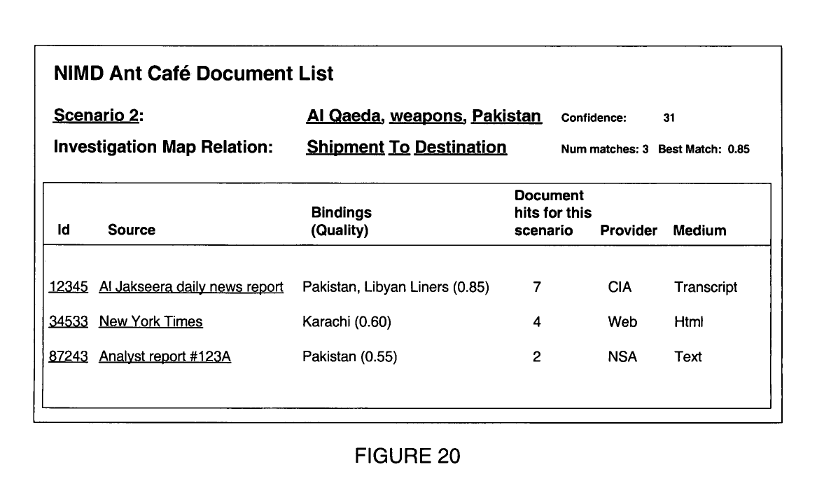

When the user clicks on a relation in the investigation map, a list of documents referenced by the selected scenario's evidence structure is displayed, as illustrated in FIG. 20. Clicking on a document in this figure would lead to the document itself, annotated with information that describes how and why the system identified the relation in the text.

The other hyperlinks in FIG. 20 would lead to displays that provide increasing detail or a different perspective on evidence for other relations in which the same binding values were found, or other relations for which the same documents provided evidence. The various confidence/strength measures shown in the figure have not yet been thought out carefully.

There are also certain user actions that merit some appropriate response where it isn't yet clear what that response ought to be. For example, it would be natural for users to click on the nodes in the investigation map in FIG. 20. Perhaps the consistent response would be to show a list of documents that support any of the relations in which the concept is involved.

### System Component Architecture

This portion of the disclosure presents an initial analysis of the component architecture of the full Ant CAFÉ system. The intention is to identify, at a high level, all system development that will be required, and show how it will fit into the full effort. The Ant Hill is shown as a single component rather than as a multi-layer, multi-agent system—thus hiding a lot of complexity.

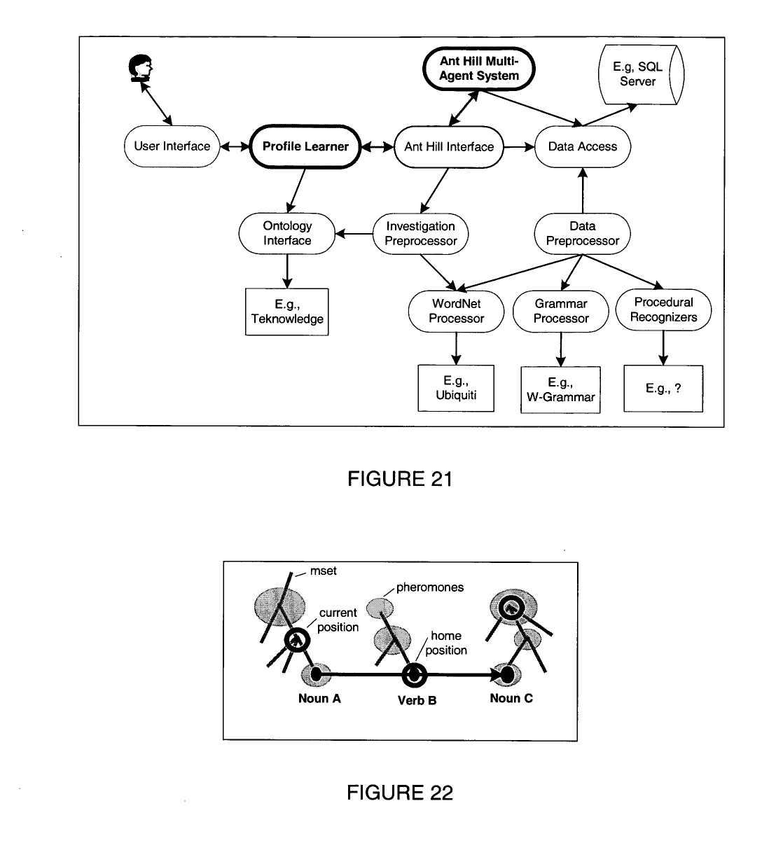

FIG. 21 illustrates proposed component architecture for the Ant CAFÉ. Each rounded rectangle represents a piece of code that will be implemented as a module: i.e., with a specified application programming interface (API) that provides exclusive access to the capabilities of the module. The square-cornered rectangles represent capabilities to be purchased. The black arrows show direct Java method calls. The thick red arrows identify XML message interfaces.

Table 5 lists and describes each component. The idea is to “partition knowledge” about the problem. In other words, all complexity in the domain should be handled by code that resides in a particular module (rather than being dealt with in multiple places throughout the system).

TABLE 5
Ant CAFÉ components

| Component | Knows About | Functionality |
|---|---|---|
| User interface | Displays to the | Analyst interview |
| | user | Investigation specification (may combine with |
| | | interview?) |
| | | Evidence review and selection |
| | | Direct profile modification (optional?) |
| Profile Learner | Constructing | Controls user interface. |
| | investigation | Interacts with Ant Hill. |
| | profiles and | |
| | concept maps | |
| Ant Hill | The capabilities | Wraps the Ant Hill. Receives concept maps and |
| Interface | of the Ant Hill | profile weights from Profile Learner. Interprets |
| | multi-agent | output of Ant Hill to answer requests from Profile |
| | system | Learner. |
| Ant Hill Multi- | Constructing | Paragraph clustering |
| Agent System | evidence from | Evidence relation recognition |
| | documents to | Evidence structure self-organization |
| | corroborate | |
| | concept maps | |
| Data Access | SQL. Ant Hill | Reads and writes data. Integrates raw text with |
| | preprocessing | preprocessing information as needed for relation |
| | representations. | recognition. |
| Ontology | The capabilities | Wraps the ontologies. Uses the Teknowledge |
| Interface | of the | ontology browsing module to provide information |
| | Teknowledge | about concepts and relations |
| | ontologies | |
| Investigation | How to add msets | Extends input to meet needs of Ant Hill (with |
| preprocessor | and text patterns | msets and text patterns). |
| | to concept maps | |
| Data | Preprocesses | Drives preprocessing. This is a separate system, |
| preprocessor | every document | run as a batch process on the data, prior to |
| | to create metadata | handling investigations. |
| | for every | |
| | document and to | |
| | prepare for | |
| | pattern matching | |
| WordNet | How to use the | Wraps Ubiquiti's code (or its equivalent). Will |
| processor | external code that | create metadata and index each paragraph. |
| | will provide | |
| | WordNet-related | |
| | capabilities | |
| Grammar | How to use | Wraps W-Grammar (or its equivalent). Will create |
| processor | external code that | grammatical markup for all text. |
| | will provide | |
| | partial text | |
| | parsing. | |
| Procedural | How to identify | Will wrap a COT tool if available, or a cluster of |
| recognizers | names, dates, | capabilities obtained from wherever. |
| | places, and other | |
| | special text | |
| | elements | |

Table 6 identifies XML messages that can be used for communication between the Profile Learner and the Ant Hill. All communication occurs in pairs of messages: a request sent by the Profile Learner to the Ant Hill interface, and a response from the Ant Hill interface. Responses should be essentially synchronous. For most messages, the response will confirm receipt of the message and the current status of processing. The ListEvidenceResponse message will return evidence, as available at that moment.

TABLE 6
XML messages for communication between
the Profile Learner and the Ant Hill Interface

| Request | Response |
|---|---|
| Initiate investigation | confirmation |
| List evidence | return current evidence |
| Modify investigation | confirmation |
| priorities | |
| End investigation | confirmation |

### Evidence Assembly Design

This portion of the disclosure describes an implementation for extending the Ant Hill demo to include evidence assembly.

Objectives

The process of assembling evidence using swarm intelligence is a radical and powerful idea. The key objective of this demo is to communicate the nature of evidence assembly and its feasibility.

The initial goal is to get a simple version of evidence assembly working quickly. We do not expect it efficiently produce coherent scenarios at this time. Rather, we want the system at a point where we can watch the assembly process to identify where it is working and where it is not, thereby supporting an iterative process of improvement.

Strategy

We will use a swarm intelligence strategy where matched relations maximize order through numerous local decisions that seek to increase the degree of compatibility between joined matches. Matches are concept map relations instantiated by words found in text. Matches join other matches to form evidence structures, also called scenarios. Scenarios can have any number of matches associated with each relation in the concept map.

Decisions about joining other matches will occur within a space structured by subsumption—the tree-structured msets that detail the words considered as evidence for each concept map concept and relation. FIG. 22 shows a match relation in blue, with two nouns joined by a verb. The green tree structures show the msets associated with each noun and verb in the concept map relation. The tan circles show the strength of pheromones associated with nodes in each mset. As matches consider other matches and decide whether to join together, the match agents identify the most-specific-subsuming (MSS) concept that subsumes the corresponding word in each match. The MSS represents the shared meaning of the terms that might join together. Identification of nodes as the MSS for matches will result in pheromone deposits at those nodes.

The rings in FIG. 22 show the current positions of the illustrated match. Matches will regularly adjust their current positions according to the pull of pheromones from nodes higher in the mset trees; and there will also be a rubber-band effect pulling on matches' current positions to return to their home positions (the mset node of the synset that was matched in the text). Thus, pheromone deposits will serve to dynamically identify the levels of abstraction that are appropriate points for crystallizing the shared meaning of matches that join to constitute scenarios.

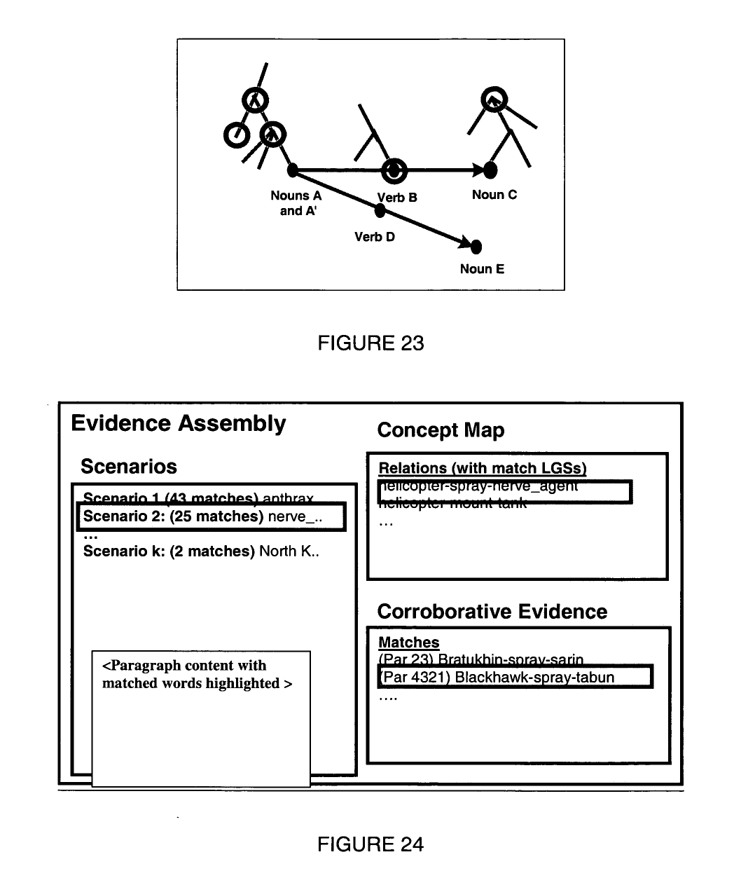

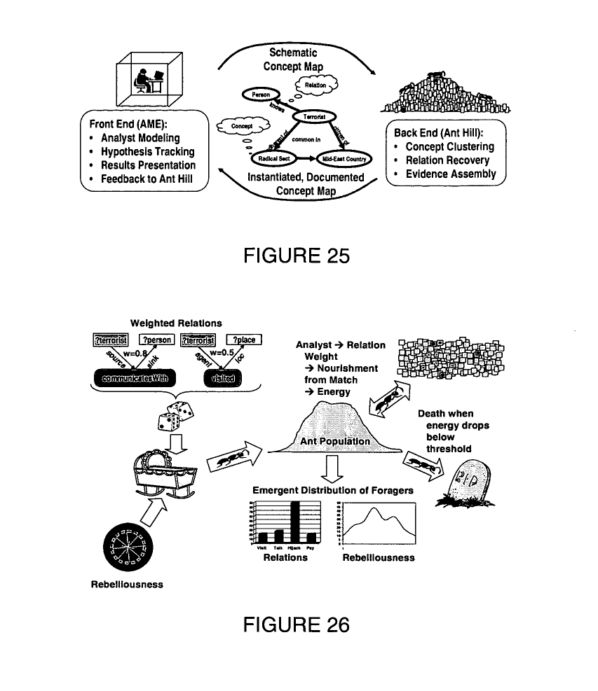

A match's current positions will affect the match's current willingness to join with other matches. Matches will be most willing to join with other matches when joining causes a relatively small displacement of their current positions. Joining forces the current positions of all involved matches to be located at the MSS nodes. FIG. 23 shows two matches joined at a node. The purple ring is the MSS of the previous positions of that node for the blue and red matches. After joining, the purple ring identifies the current position of both relations.

Assembly decisions may involve two single matches joining, two structures joining, or matches splitting from their current structures to join another. All such decisions will be made as stochastic functions of the change in local order (a.k.a. negative entropy) of matches and structures. Two measures on a match or evidence structure assess (different perspectives on) this local order: happiness and compatibility.

A match will experience maximum happiness if it is bound in a structure where all of its nodes are at their home positions: this is the most specific meaning of the match, and the maximal expression of its information content. The further the MSSs of the match in the evidence structure from their home positions, the less happy the match will be with its placement, and the more likely it will be to leave the structure to join another. Thus happiness assesses the alignment between a match and the semantic lattice.

A match will experience maximum compatibility if it is aligned topologically with (a subgraph of) an evidence structure. The greater the number of matches in one evidence structure that are joined with those of another, the better the overall alignment of the two evidence structures, and the more reluctant any one match will be to move away from its partner in the other structure. In the current implementation, the relation ants that generate the matches are themselves derived directly from a static concept map template, and remember the location in that template that they represent, so there is little need for decisions based on observed compatibility. However, when we permit dynamic changes in the topology of evidence structures, compatibility will be an important heuristic for addressing the graph matching problem.

If an evidence structure decides to accept a new match's request to join, it is possible that accepting the join request will force all of the corresponding matches already in the structure to raise their MSS to accommodate the new match. In this situation, the structure will not be likely to accept the new match because the total happiness of the structure may decrease instead of increase.

Display Mockup

FIG. 24 illustrates a quick mockup for how the evidence assembly display will look. There are several levels of drill down. The list of scenarios will identify the largest evidence structures assembled so far. Selecting a scenario and a relation from the concept map populates the list of paragraphs offering corroborative evidence. Clicking on the paragraph will display its contents, with matched words highlighted.

Objects

matchPopulation—the set of match agents

matchAgent—a concept map relation matched against text words (an agent

created by a relation identification agent)

matchSpace—the mset trees that constitute the space for pheromones deposit

evidenceStructure (a.k.a. Scenario in the context of user action)—an assembly of

joined match agents—each of which, however, retains its ability to move

Algorithm

The following pseudocode describes the execution logic of evidence assembly.

matchPopulation.runOneCycle( )

randomize sequence of agent moves

update pheromones (propogate down mset trees and evaporate)

for each match agent (m)

determine number of agent moves. For each move
// searching for a join partner
for each free match node
decide whether to move current position up or down in its mset tree
choose a potential partner (p) from matches for the same concept map relation
(will have 3 MSSs) or a linked concept map relation (will have one MSS)
identify the MSSs and deposit pheromones there
// decisions about joining based on delta happiness (prospective—current)
// merging structures
calculate new MSSs for all relations in m and p
m's structure chooses whether to request to join p's structure
if yes, p's structure decides whether to accept
// single relation joins other single relation or structure
if not merged:
m decides whether to leave its structure to join p or p's structure
if yes, p or p's structure decides whether to accept

Knowing what we don't know is critical for responsible decision making, yet understanding the limits of our knowledge is a largely unexplored field in information management. Two factors limit our ability to know the state of our ignorance. First, we may ascribe too much credence to the evidence that we have in hand. Second, we may not recognize when critical evidence is lacking. The Ant CAFÉ team has conceived novel mechanisms that can address these shortcomings.

By applying known psychological standards to an active model of an analyst and a stream of incoming data, we can assess the persuasiveness of that data, enabling the analyst to discount evidence of low persuasive value and focus attention on those items that are most likely to make a difference in the analysis process.

By applying adaptive methods to our stigmergic search mechanisms, we can estimate the lack of data in areas of interest, identifying holes in the body of underlying evidence and providing guidance to primary data collection efforts.

Overview of the Ant CAFÉ Architecture

FIG. 26 shows the basic information flow in the overall Ant CAFÉ architecture. The Analyst Modeling Environment (AME) interacts with the Glass Box Environment, maintaining a model of the analyst and formulating hypotheses and scenarios of interest in the form of schematic concept maps, which are passed to the Ant Hill. The Ant Hill uses swarming techniques [Parunak 1997] to cluster documents, identify specific relations from the concept map for which the documents give evidence, and assemble this evidence into the concept map, which is returned to the analyst.

Assessing Persuasiveness of Evidence

One aspect of “knowing what you don't know” is making sure that you actually have solid evidence for what you think you know. To help an analyst become aware of the lack of suitable information in an area we propose to develop a persuasiveness metric that will indicate how certain the analyst can be about a given hypothesis, proposition, or set of facts. Such a metric will not only help the analyst recognize potential lacunas, but also indicate when sufficiently strong evidence has been acquired and it is time to move on to another aspect of the problem.

TABLE 7
Persuasiveness Factors.-We will combine information
metrics capturing several of the factors shown below to compute
a novel measure of evidence effectiveness

| Source Factors | Message Factors |
|---|---|
| Credibility: Expertness & | Arguments order |
| Trustworthiness | Explicit conclusions |
| Similarity | Example vs. statistics |
| Liking | One vs. two-sided |
| | Fear appeals |
| | Foot-in-the-door |
| | Door-in-the-face |
| Receiver Factors | Contextual Factors |
| General persuasibility | Primacy-recency |
| Personality traits | Medium: person-to-person |
| Warning | vs. computer |

A review of the available literature in evidence persuasiveness (e.g., [O'Keefe 2002]) indicates a number of factors affecting the persuasiveness of an argument. These factors fall into four classes (Table 7).

Source factors are intrinsic to the source of the evidence. For example, evidence related to biological weapons of mass destruction (WMD) found in a web site maintained by a professional society of biology researchers is apt to carry higher weight than that found in an internet chat room. There are other source factors of a subtler nature. For example, evidence will carry more weight if the same data is found in a collection of similar sites.

Receiver factors relate to the analyst receiving the information. For example, a particular analyst may be easier to convince than another, or have personal biases for or against certain types of evidence. (Biases are a special case of the more general concept of personality traits.)

The context in which the analyst is working also affects the perceived weight of available evidence. For example, it is common to weight recent evidence more than that seen a while ago (recency), or to allow the very first information datum to color one's perception of subsequent data (primacy).

Finally, several message factors relate to how the information in a piece of evidence is presented. Consider the order in which arguments are presented in a document. A given analyst may find more persuasive an argument that builds from the weakest point to the strongest, while another analyst may be swayed by a chain of reasoning that starts with its best foot forward.

The broad scope of factors in Table 7 suggests the challenge of computing a practical, extensible, yet useful persuasiveness metric. We propose the following research approach. (1) Conduct a more extensive review of the available literature to identify persuasiveness factors of proven importance, (2) Select several prototype persuasiveness metrics based various combinations of factors (utilizing only factors that can be effectively and efficiently measured in the Glass Box Environment). (3) Conduct experiments to select the most appropriate persuasiveness metric for MMD. (4) Integrate the resulting metric in the Ant CAFÉ system.

The benefits of the proposed research extend beyond the Ant CAFÉ project. We will develop a persuasiveness metric that can be used by other researchers in the NIMD team, and we will work with the Glass Box team to insert our software into that environment.

Assessing Lack of Evidence

Our innovation for detecting lack of evidence focuses on the relation recovery phase of the Ant Hill processing, in which a population of digital ants, each representing a single relation, swarms over the documents seeking for evidence of their respective relations. Currently, this population is static, with the number of ants for each relation set as a configuration parameter. This scheme can waste computational resources, since the same number of ants is generated for a relation that is abundantly attested as for one that is weakly attested, even though the latter may not return any evidence. We propose to let the population of relation ants adapt dynamically. This process is outlined in FIG. 26.
On the left, new ants are continually generated, with three main parameters. The relation that an ant seeks is determined by the relations in the concept map from the AME. The ant's energy level is determined by the priority assigned by the analyst to that relation. The ant's rebelliousness (the likelihood that it will explore new documents rather than exploiting previously discovered ones) is set randomly. (A random component to the relation and energy decisions is also applied to break symmetries among ants.)
As ants forage over the body of documents (top right), they expend energy. At the same time, they are nourished by the relations that they retrieve, gaining energy proportional to the relation's weight.
If an ant's energy level drops below a threshold, it dies (lower right).

The interaction of these three processes yields two emergent effects that can be monitored to detect missing data. First, the distribution of living ants (bottom) reflects the relations that are attested in the data, since the survival of these ants depends on their success in finding matches that replenish their energy supply. (It also self-adjusts to provide the right degree of rebelliousness.) Second, the stream of dead ants (lower right) documents relations that were sought but not found, and thus that are not attested in the data. We hypothesize that with appropriate ant generation and nourishment parameters, these two sources of information can be used to annotate the concept map that is returned to the analyst with information about evidence that is lacking, in addition to the positive documentation currently returned.

The Integration Opportunity

The Ant CAFÉ architecture provides a way to use analyst feedback in the adaptation process. The Lack of Evidence technology as described above uses feedback in the form of the priorities that the Ant CAFÉ learns to associate with the various relations and concept maps being matched with data. If an evidence persuasiveness metric were available, that could also help guide adaptation. More persuasive data could yield more nourishment than less persuasive data, with the result that the emergent ant population would contain information not just about the presence of data, but also its relative quality.

### Bibliography

[1] R. Alonso, J. Bloom, and H. Li. SmartSearch for Obsolete Parts Acquisition. Technical Report, Sarnoff, Princeton, N.J., 2002.
[2] Applied Semantics. Applied Semantics, Inc. 2002. www.appliedsemantics.com.
[3] M. Balabanovic and Y. Shoham. Fab: content-based, collaborative recommendation. Communications of the ACM, 40(3), 1997.
[4] E. Bonabeau, G. Theraulaz, V. Fourcassié, and J.-L. Deneubourg. The Phase-Ordering Kinetics of Cemetery Organization in Ants. Physical Review E, 4:4568-4571, 1998.
[5] W. A. Cook. Case Grammar: Development of the Matrix Model. Washington, Georgetown University, 1979.
[6] W. A. Cook. Case Grammar Theory. Washington, D.C., Georgetown University Press, 1989.
[7] W. A. Cook. Case Grammar Applied. Arlington, Tex., The Summer Institute of Linguistics and The University of Texas at Arlington, 1998.
[8] B. J. Copeland. The Church-Turing Thesis. 1997. Web Page, http.//plato.stanford.edu/entries/church-turing/.
[9] J. L. Deneubourg, S. Goss, N. Franks, A. Sendova-Franks, C. Detrain, and L. Chretien. The Dynamics of Collective Sorting: Robot-Like Ants and Ant-Like Robots. In J. A. Meyer and S. W. Wilson, Editors, From Animals to Animats: Proceedings of the First International Conference on Simulation of Adaptive Behavior, pages 356-365. MIT Press, Cambridge, Mass., 1991.
[10] C. Fuller and J. Karnes. Virage SmartEncode™ Process: Technical Overview v5.0. Virage, Inc., San Mateo, Calif., 2002. URL http:///www.virage.com/products/details.cfm?productID=4&categoryID=1.
[11] K. M. Hoe, W. K. Lai, and T. S. Y. Tai. Homogeneous Ants for Web Document Similarity Modeling and Categorization. In Proceedings of Ants 2002, 2002.
[12] T. Joachims, T. Mitchell, D. Freitag, and R. Armstrong. WebWatcher: A learning apprentice for the World Wide Web. In Proceedings of AAAI 1995 Spring Symp. Information Gathering from Heterogeneous, Distributed Environments, AAAI Press, 1995.
[13] R. E. Longacre. An Apparatus for the Identification of Paragraph Types. Notes on Linguistics, 15(July):5-22, 1980.
[14] T. Malone, K. Grant, F. Turbak, S. Brobst, and M. Cohen. Intelligent information sharing systems. Communications of the ACM, 30:390-402, 1987.
[15] G. A. Miller. WordNet: A Lexical Database for the English Language. 2002. Web Page, http://www.cogsci.princeton.edu/˜wn/.
[16] A. Moukas. Amalthaea: Information Discovery and Filtering using a Multiagent Evolving Ecosystem. Applied Artificial Intelligence, 11(5):437-457, 1997.
[17] H. V. D. Parunak. Case Grammar: A Linguistic Tool for Engineering Agent-Based Systems. Industrial Technology Institute, Ann Arbor, 1995. URL http://www.erim.org/˜van/casegram.pdf.
[18] H. V. D. Parunak. ‘Go to the Ant’: Engineering Principles from Natural Agent Systems. Annals of Operations Research, 75:69-101, 1997.
[19] H. V. D. Parunak and S. A. Brueckner. Model-Based Pattern Detection for Biosurveillance using Stigmergic Software Agents. In Proceedings of VWSIM 2002, pages (forthcoming), 2002.
[20] H. V. D. Parunak, S. A. Brueckner, J. Sauter, and J. Posdamer. Mechanisms and Military Applications for Synthetic Pheromones. In Proceedings of Workshop on Autonomy Oriented Computation, 2001.
[21] J. Pazzani, Muramatsu, and D. Billsus. Syskill & Webert: Identifying interesting web sites. In Proceedings of 13th Nat'l Conf. AI AAAI 96, pages 54-61, AAAI Press, 1996.
[22] M. J. Pazzani. Representation of electronic mail filtering profiles: a user study. In Proceedings of Intelligent User Interfaces 2000, pages 202-206, 2000.
[23] PostgresQL. PostgresQL. 2002. http://www.us.postgresql.org/.
[24] ProMED. About ProMED-Mail. 2001. Web Site, http://www.promedmail.org/pls/askus/f?p=2400:1950:227944.
[25] J. Rocchio. Relevance feedback information retrieval. In G. Salton, Editor, The SMART retrieval system-experiments in automated document processing, pages 313-323. Prentice-Hall, Englewood Cliffs, 1971.
[26] H. Sakagami and T. Kamba. Learning personal preferences on online newspaper articles from user behaviors. In Proceedings of 6th Int'l World Wide Web Conf., pages 291-300, 1997.
[27] Sarnoff. Netrospect. 2002. Web page, http://www.sarnoff.com/intemet_telecom/netrospect_web_tool/index.asp.
[28] J. A. Sauter, R. Matthews, H. V. D. Parunak, and S. Brueckner. Evolving Adaptive Pheromone Path Planning Mechanisms. In Proceedings of Autonomous Agents and Multi-Agent Systems (AAMAS02), pages (forthcoming), 2002.
[29] B. Sheth and P. Maes. Evolving agents for personalized information filtering. In Proceedings of IEEE Conf. on Al for applications, 1993.
[30] A. M. Turing. On Computable Numbers, with an application to the Entscheidungsproblem. Proc. Lond. Math. Soc., 2(42):230-265, 1936.
[31] P. Wegner. Why Interaction is More Powerful than Algorithms. Communications of the ACM, 40(5 (May)):81-91, 1997.
[32] P. Wegner. Interactive Foundations of Computing. Theoretical Computer Science, 192(2):315-351, 1998.
[33] Wintertree. WGrammar Parts of Speech matching. 2002. HTML Page, http://www.wintertree-software.com/dev/wgramrnmar/parts-of-speech.html.
[34] T. Yan and H. Garcia-Molina. SIFT—a tool for wide-area information dissemination. In Proceedings of 1995 USENIX Technical Conf., pages 177-186, 1995.
   References
Camazine, S., J.-L. Deneubourg, et al. (2001). Self-Organization in Biological Systems. Princeton, N.J., Princeton University Press.
Grishman, R. (1997). Information Extraction: Techniques and Challenges. Information Extraction: A Multidisciplinary Approach to an Emerging Information Technology. M. T. Pazienza. Berlin, Springer.
Smeaton, A. (1999). Using NLP or NLP Resources for Information Retrieval Tasks. Natural Language Information Retrieval. T. Strzalkowski, Kluwer Academic Publishers: 99-112.
Soderland, S. (1999). “Learning Information Extraction Rules for Semi-structured and Free Text.” Machine Learning 44(1-3): 233-272.
Weinstein, P. (1999). Integrating Ontological Metadata: algorithms that Ipredict semantic compatibility. Ph.D. Dissertation, Electrical Engineering and Computer Science.

Ann Arbor, University of Michigan.

1. A method of extracting information from text, comprising the steps of:
matching the text with a concept map to identify evidence relations; and
organizing the evidence relations into one or more evidence structures that represent the ways in which the concept map is instantiated in the evidence relations.

2. The method of claim 1, wherein the text is contained in one or more documents in electronic form.

3. The method of claim 2, wherein the documents are indexed on a paragraph level of granularity.

4. The method of claim 1, including the step of allowing the evidence relations to self-organize into the evidence structures.

5. The method of claim 4, including the use of feedback from the user to guide the identification of evidence relations and their self-organization into evidence structures.

6. The method of claim 1, further including the steps of:
identifying patterns in the text; and
matching the text with the concept map using the patterns.

7. The method of claim 6, wherein the patterns use linguistically-oriented regular expressions to recognize relations in the text.

8. The method of claim 1, wherein the text is preprocessed to identify basic grammatical constituents such as noun phrases and verb phrases.

9. The method of claim 8, further including the step of resolving pronoun references and similar linguistic phenomena that have a significant presence in the test.

10. The method of claim 1, wherein the evidence relations include a reference to a document, a paragraph, or metadata.

11. The method of claim 1, wherein the evidence relations include a reference to the pattern used to match the concept map relation, and the terms in the document text that were matched to the pattern.

12. The method of claim 1, wherein the evidence relations include a reference to the exact terms in the text that match to the concept map concepts and relations.

13. The method of claim 12, wherein the terms are as specific as or more specific than the corresponding concepts and relations in the concept map.

14. The method of claim 1, wherein the evidence relations include an estimate as to the confidence in the evidence relation, based on the match of the relation to the textual data.

15. The method of claim 14, wherein the confidence estimate is based in part on a measure of the absence of supporting evidence.

16. The method of claim 15, wherein the confidence reflects the degree to which the evidence relation fits with other evidence into the larger pattern defined by the concept map.

17. The method of claim 1, further including the step of clustering the text prior to matching the text with the concept map.

18. The method of claim 17, wherein the evidence structures represent the ways in which the concept map is instantiated in the document evidence by providing mutually compatible evidence relations connected to each other according to the template provided by the concept map.

19. A method of extracting information from one or more documents in electronic form, comprising the steps of:
clustering the document into clustered text;
identifying patterns in the clustered text; and
matching the patterns with the concept map to identify evidence relations, whereby the evidence relations self-organize into evidence structures that represent the ways in which the concept map is instantiated in the evidence relations.

20. The method of claim 19, including the use of feedback from the user to guide the identification of patterns, the matching of textual patterns with the concept map, and their self-organization into evidence structures.

21. The method of claim 20, wherein the documents are indexed on the paragraph level of granularity.

22. The method of claim 20, wherein the patterns use linguistically-oriented regular expressions to recognize relations in the text.

23. The method of claim 1, wherein each document is preprocessed to identify basic grammatical constituents such as noun phrases and verb phrases.

24. The method of claim 23, further including the step of resolving pronoun references and similar linguistic phenomena that have a significant presence in the test.

25. The method of claim 19, wherein the evidence relations include a reference to a document, a paragraph, or metadata.

26. The method of claim 19, wherein the evidence relations include a reference to the pattern used to match the concept map relation, and the terms in the document text that were matched to the pattern.

27. The method of claim 19, wherein the evidence relations include a reference to the exact terms in the text that match to the concept map concepts and relations.

28. The method of claim 27, wherein the terms are as specific, or more specific, than the corresponding concepts and relations in the concept map.

29. The method of claim 19, wherein the evidence relations include an estimate as to the confidence in the evidence relation, based on the match of the relation to the textual data.

30. The method of claim 29, wherein the confidence estimate is based in part on a measure of the absence of supporting evidence.

31. The method of claim 29, wherein the confidence reflects the degree to which the evidence relation fits with other evidence into the larger pattern defined by the concept map.

32. The method of claim 19, wherein the evidence structures represent the ways in which the concept map is instantiated in the document evidence by providing mutually compatible evidence relations connected to each other according to the template provided by the concept map.
